(19) United States
(12) Patent Application Publication
(10) Pub. No.: US 2019/0021083 A1
(43) Pub. Date: Jan. 17, 2019

(54) NARROWBAND UPLINK CONTROL FOR WIRELESS COMMUNICATIONS

(71) Applicant: QUALCOMM Incorporated, San Diego, CA (US)

(72) Inventor: Nir Tishbi, Kfar Saba (IL)

(21) Appl. No.: 15/647,954

(22) Filed: Jul. 12, 2017

(51) Int. Cl. H04W 72/04; H04L 5/00; H04L 25/02; H04L 1/00; H04W 72/12

(52) U.S. Cl. CPC H04W 72/0413; H04L 5/0053; H04L 25/0204; H04W 72/1231; H04L 25/022; H04L 1/0048; H04L 25/0228; H04L 1/0047

(57) ABSTRACT

Methods, systems, and devices for wireless communication are described. A narrowband receiver may be implemented in a base station and may be used to perform low signal to noise ratio (SNR) processing and carrier frequency offset (CFO) cancellation in order to detect or decode uplink control information (UCI) transmitted by another wireless device, such as a user equipment (UE). As described herein, processing of the UCI may include SNR boosting, noise estimation, parallel processing of data and pilot symbols, and peak searches performed across sliding windows applied to multiple decoding hypotheses. By processing the UCI according to the described techniques, the base station may improve performance of a given wireless communications system.

### BACKGROUND

The following relates generally to wireless communication, and more specifically to narrowband uplink control for wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE).

Some wireless devices may communicate using a portion of a frequency spectrum. For example, narrowband communication may include narrowband LTE (NB-LTE) communication, machine to machine (M2M) communication, machine type communication (MTC), and NB-Internet of Things (NB-IoT) communication, among others. In some cases, narrowband communication may be employed in communications over large distances and/or challenging conditions. For example, an MTC device (e.g., a sensor) may be located remotely or in an obstructed location (e.g., a basement). Additionally or alternatively, some devices may be examples of power-limited devices. Such devices may operate in accordance with power constraints, which may in some cases affect throughput for the wireless communications system. Improved techniques for uplink control may be desired.

### SUMMARY

The described techniques relate to improved methods, systems, devices, or apparatuses that support uplink control for wireless communications. Generally, the described techniques provide for a receiver that supports efficient uplink control procedures. The receiver may be operable to receive uplink control information at large ranges and/or in difficult communication scenarios (e.g., low signal to noise ratio (SNR)). In some examples, the receiver may support low SNR processing and/or carrier frequency offset (CFO) cancellation (e.g., in order to facilitate signal detection, SNR estimation, and/or signal decoding).

A method of wireless communication at a base station is described. The method may include receiving, from a UE, uplink control information (UCI) including a plurality of resource units (RUs) that each include at least one slot containing a set of data symbols and a set of reference symbols, calculating, for each slot of each RU of the plurality of RUs, a data symbol estimate based at least in part on the set of data symbols of the slot and a reference symbol estimate based at least in part on the set of reference symbols of the slot, and decoding at least a portion of the UCI based at least in part on the data symbol estimates and the reference symbol estimates.

An apparatus for wireless communication at a base station is described. The apparatus may include means for receiving, from a UE, UCI including a plurality of RUs that each include at least one slot containing a set of data symbols and a set of reference symbols, means for calculating, for each slot of each RU of the plurality of RUs, a data symbol estimate based at least in part on the set of data symbols of the slot and a reference symbol estimate based at least in part on the set of reference symbols of the slot, and means for decoding at least a portion of the UCI based at least in part on the data symbol estimates and the reference symbol estimates.

Another apparatus for wireless communication at a base station is described. The apparatus may include a processor, memory in electronic communication with the processor, and instructions stored in the memory. The instructions may be operable to cause the processor to receive, from a UE, UCI including a plurality of RUs that each include at least one slot containing a set of data symbols and a set of reference symbols, calculate, for each slot of each RU of the plurality of RUs, a data symbol estimate based at least in part on the set of data symbols of the slot and a reference symbol estimate based at least in part on the set of reference symbols of the slot, and decode at least a portion of the UCI based at least in part on the data symbol estimates and the reference symbol estimates.

A non-transitory computer readable medium for wireless communication at a base station is described. The non-transitory computer-readable medium may include instructions operable to cause a processor to receive, from a UE, UCI including a plurality of RUs that each include at least one slot containing a set of data symbols and a set of reference symbols, calculate, for each slot of each RU of the plurality of RUs, a data symbol estimate based at least in part on the set of data symbols of the slot and a reference symbol estimate based at least in part on the set of reference symbols of the slot, and decode at least a portion of the UCI based at least in part on the data symbol estimates and the reference symbol estimates.

Some examples of the method, apparatus, and non-transitory computer-readable medium described above may further include processes, features, means, or instructions for transmitting, to the UE, a message in a narrowband transmission within a radio frequency spectrum band, wherein the UCI may be received in response to the message.

In some examples of the method, apparatus, and non-transitory computer-readable medium described above, calculating the data symbol estimate for each slot comprises calculating a first noise cancellation average for the slot. In some examples of the method, apparatus, and non-transitory computer-readable medium described above, calculating the reference symbol estimate for each slot comprises calculating a second noise cancellation average for the slot.

In some examples of the method, apparatus, and non-transitory computer-readable medium described above, the UCI may be received in a narrowband transmission within a radio frequency spectrum band.

Some examples of the method, apparatus, and non-transitory computer-readable medium described above may further include processes, features, means, or instructions for storing each data symbol estimate in a data buffer. Some examples of the method, apparatus, and non-transitory computer-readable medium described above may further include processes, features, means, or instructions for storing each reference symbol estimate in a pilot buffer, wherein decoding the symbol may be based at least in part on the stored data buffer and the stored pilot buffer.

Some examples of the method, apparatus, and non-transitory computer-readable medium described above may further include processes, features, means, or instructions for performing a first Fourier transform on the stored pilot buffer to obtain a frequency-domain pilot sequence. Some examples of the method, apparatus, and non-transitory computer-readable medium described above may further include processes, features, means, or instructions for performing a second Fourier transform on the stored data buffer to obtain a frequency-domain data sequence, wherein decoding at least the portion of the UCI may be based at least in part on the frequency-domain pilot sequence and the frequency-domain data sequence.

Some examples of the method, apparatus, and non-transitory computer-readable medium described above may further include processes, features, means, or instructions for computing a first hypothesis function and a second hypothesis function based at least in part on the frequency-domain pilot sequence and the frequency-domain data sequence.

Some examples of the method, apparatus, and non-transitory computer-readable medium described above may further include processes, features, means, or instructions for performing a detection operation based at least in part on the first and second hypothesis functions, wherein decoding at least the portion of the UCI may be based at least in part on the detection operation.

In some examples of the method, apparatus, and non-transitory computer-readable medium described above, the detection operation comprises a sliding window operation and a peak search operation.

In some examples of the method, apparatus, and non-transitory computer-readable medium described above, the sliding window operation comprises convolving a pulse with the first hypothesis function to obtain a first windowed function. Some examples of the method, apparatus, and non-transitory computer-readable medium described above may further include processes, features, means, or instructions for convolving the pulse with the second hypothesis function to obtain a second windowed function.

In some examples of the method, apparatus, and non-transitory computer-readable medium described above, a width of the pulse may be determined based at least in part on a Doppler spread of a channel over which the UCI may be received.

In some examples of the method, apparatus, and non-transitory computer-readable medium described above, the peak search operation comprises determining a first maximum value of the first windowed function. Some examples of the method, apparatus, and non-transitory computer-readable medium described above may further include processes, features, means, or instructions for determining a second maximum value of the second windowed function. Some examples of the method, apparatus, and non-transitory computer-readable medium described above may further include processes, features, means, or instructions for selecting a greater of the first maximum value and the second maximum value, wherein decoding at least the portion of the UCI may be based at least in part on the selection.

Some examples of the method, apparatus, and non-transitory computer-readable medium described above may further include processes, features, means, or instructions for comparing at least one of the first maximum value or the second maximum value to a threshold. Some examples of the method, apparatus, and non-transitory computer-readable medium described above may further include processes, features, means, or instructions for classifying the UCI as a valid transmission based at least in part on the comparison.

Some examples of the method, apparatus, and non-transitory computer-readable medium described above may further include processes, features, means, or instructions for selecting the threshold based at least in part on a false-alarm/missed-detection (FA/MD) rate.

In some examples of the method, apparatus, and non-transitory computer-readable medium described above, the likelihood operation may be based at least in part on an expected CFO corresponding to a channel over which the UCI may be received.

In some examples of the method, apparatus, and non-transitory computer-readable medium described above, the UCI may be received over multiple antennas.

### BRIEF DESCRIPTION OF THE DRAWINGS

FIG. 1 illustrates an example of a system for wireless communication that supports narrowband uplink control for wireless communications in accordance with aspects of the present disclosure.

FIG. 2 illustrates an example of a wireless communications system that supports narrowband uplink control for wireless communications in accordance with aspects of the present disclosure.

FIG. 3 illustrates an example of a receiver block diagram that supports narrowband uplink control for wireless communications in accordance with aspects of the present disclosure.

FIGS. 4 through 6 show block diagrams of a device that supports narrowband uplink control for wireless communications in accordance with aspects of the present disclosure.

FIG. 7 illustrates a block diagram of a system including a base station that supports narrowband uplink control for wireless communications in accordance with aspects of the present disclosure.

FIG. 8 illustrates a method for narrowband uplink control for wireless communications in accordance with aspects of the present disclosure.

### DETAILED DESCRIPTION

Some wireless communications systems may support the use of various signals. For example, narrowband signals may limit the bandwidth over which a given device is operable to monitor for transmissions to be received or modulate transmissions to be sent. Such considerations may support power-efficient operations of the device or otherwise benefit the wireless communications system. However, in some cases such power limited devices (e.g., or non-power-limited devices that are operable to communicate over a portion of a spectrum, such as a narrowband portion of a spectrum) may experience difficult communication environments. For example, such devices may be located remotely relative to a network node (e.g., a base station) or communications originating at such devices may experience significant signal attenuation (e.g., due to various obstructions, interference from other transmissions, etc.). In some cases, communications originating at such devices may have a limited transmission power (e.g., due to hardware limitations and/or power constraints at the transmitting device), which may negatively affect the SNR at a receiving device.

In some cases, after receiving a transport block (e.g., over a narrowband physical downlink shared channel (NPDSCH)), a device (e.g., a NB-IoT device) may transmit UCI over an uplink control channel (e.g., narrowband physical uplink shared channel (NPUSCH) Format 2). For example, the UCI may comprise a single bit that designates acknowledgement (e.g., or negative acknowledgement) of the preceding NPDSCH transport block (e.g., may provide similar functionality to the physical uplink control channel (PUCCH) in Long Term Evolution (LTE) communications systems). As described below, a receiver designed in accordance with the present disclosure may support processing of low SNR UCI in narrowband communications systems.

Aspects of the disclosure are initially described in the context of a wireless communications system. Aspects of the disclosure are then described in the context of transmission schemes, message formats, and process flows that support narrowband random access. Aspects of the disclosure are further illustrated by and described with reference to apparatus diagrams, system diagrams, and flowcharts that relate to narrowband uplink control for wireless communications. In some examples, a receiver is described as being or including a narrowband receiver, but the present techniques are not limited to this application.

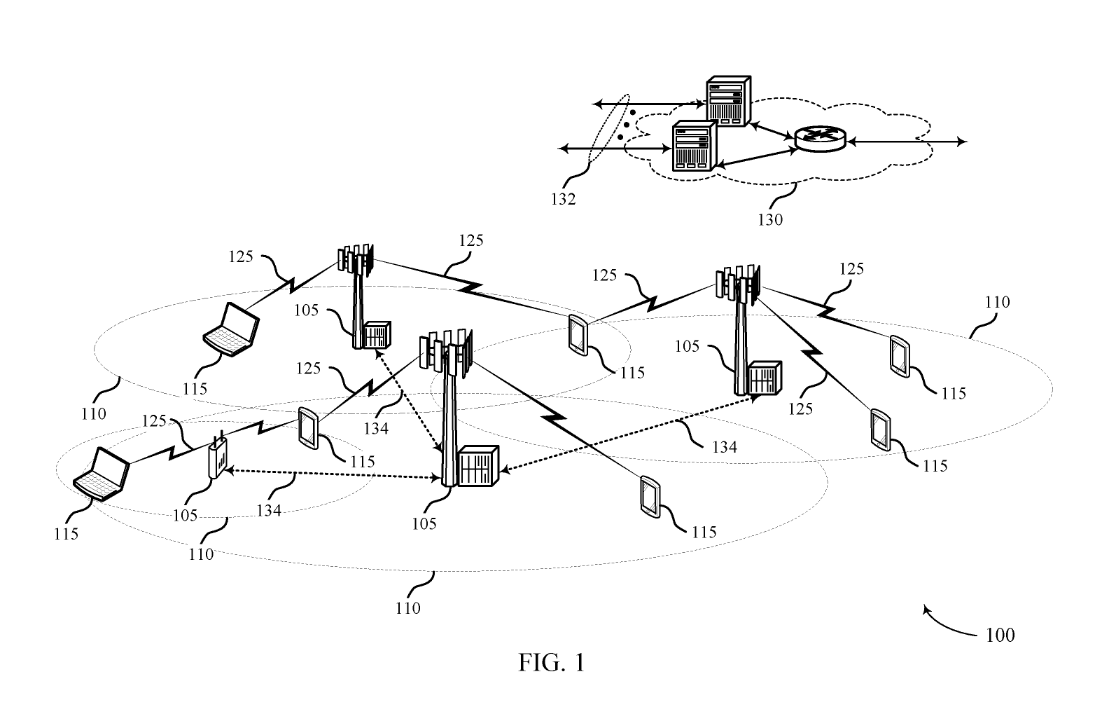

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be an LTE, LTE-Advanced (LTE-A) network, or a New Radio (NR) network. In some cases, wireless communications system 100 may support enhanced broadband communications, ultra-reliable (i.e., mission critical) communications, low latency communications, and communications with low-cost and low-complexity devices. Wireless communications system 100 may support narrowband uplink control for wireless communications.

Base stations 105 may wirelessly communicate with UEs 115 via one or more base station antennas. Each base station 105 may provide communication coverage for a respective geographic coverage area 110. Communication links 125 shown in wireless communications system 100 may include uplink transmissions from a UE 115 to a base station 105, or downlink transmissions, from a base station 105 to a UE 115. Control information and data may be multiplexed on an uplink channel or downlink according to various techniques. Control information and data may be multiplexed on a downlink channel, for example, using time division multiplexing (TDM) techniques, frequency division multiplexing (FDM) techniques, or hybrid TDM-FDM techniques. In some examples, the control information transmitted during a transmission time interval (TTI) of a downlink channel may be distributed between different control regions in a cascaded manner (e.g., between a common control region and one or more UE-specific control regions).

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as evolved NodeBs (eNBs) 105.

UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of Things (IoT) device, an Internet of Everything (IoE) device, a machine type communication (MTC) device, an appliance, an automobile, or the like.

Wireless communications system 100 may operate in an ultra-high frequency (UHF) frequency region using frequency bands from 700 MHz to 2600 MHz (2.6 GHz), although some networks (e.g., a wireless local area network (WLAN)) may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communications system 100 may also utilize extremely high frequency (EHF) portions of the spectrum (e.g., from 30 GHz to 300 GHz). This region may also be known as the millimeter band, since the wavelengths range from approximately one millimeter to one centimeter in length. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions.

Thus, wireless communications system 100 may support millimeter wave (mmW) communications between UEs 115 and base stations 105. Devices operating in mmW or EHF bands may have multiple antennas to allow beamforming. That is, a base station 105 may use multiple antennas or antenna arrays to conduct beamforming operations for directional communications with a UE 115. Beamforming (which may also be referred to as spatial filtering or directional transmission) is a signal processing technique that may be used at a transmitter (e.g., a base station 105) to shape and/or steer an overall antenna beam in the direction of a target receiver (e.g., a UE 115). This may be achieved by combining elements in an antenna array in such a way that transmitted signals at particular angles experience constructive interference while others experience destructive interference.

Multiple-input multiple-output (MIMO) wireless systems use a transmission scheme between a transmitter (e.g., a base station 105) and a receiver (e.g., a UE 115), where both transmitter and receiver are equipped with multiple antennas. Some portions of wireless communications system 100 may use beamforming. For example, base station 105 may have an antenna array with a number of rows and columns of antenna ports that the base station 105 may use for beamforming in its communication with UE 115. Signals may be transmitted multiple times in different directions (e.g., each transmission may be beamformed differently). A mmW receiver (e.g., a UE 115) may try multiple beams (e.g., antenna subarrays) while receiving the synchronization signals.

In some cases, the antennas of a base station 105 or UE 115 may be located within one or more antenna arrays, which may support beamforming or MIMO operation. One or more base station antennas or antenna arrays may be collocated at an antenna assembly, such as an antenna tower. In some cases, antennas or antenna arrays associated with a base station 105 may be located in diverse geographic locations. A base station 105 may multiple use antennas or antenna arrays to conduct beamforming operations for directional communications with a UE 115.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” and “channel” may be used interchangeably herein. A UE 115 may be configured with multiple downlink CCs and one or more uplink CCs for carrier aggregation. Carrier aggregation may be used with both FDD and TDD component carriers.

In some cases, wireless communications system 100 may utilize enhanced component carriers (eCCs). An eCC may be characterized by one or more features including: wider bandwidth, shorter symbol duration, shorter TTIs, and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 MHz, etc.) at reduced symbol durations (e.g., 16.67 microseconds). A TTI in eCC may consist of one or multiple symbols. In some cases, the TTI duration (that is, the number of symbols in a TTI) may be variable.

A shared radio frequency spectrum band may be utilized in an NR shared spectrum system. For example, an NR shared spectrum may utilize any combination of licensed, shared, and unlicensed spectrums, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

In some cases, wireless system 100 may utilize both licensed and unlicensed radio frequency spectrum bands. For example, wireless system 100 may employ LTE License Assisted Access (LTE-LAA) or LTE Unlicensed (LTE U) radio access technology or NR technology in an unlicensed band such as the 5 GHz Industrial, Scientific, and Medical (ISM) band. When operating in unlicensed radio frequency spectrum bands, wireless devices such as base stations 105 and UEs 115 may employ listen-before-talk (LBT) procedures to ensure the channel is clear before transmitting data. In some cases, operations in unlicensed bands may be based on a CA configuration in conjunction with CCs operating in a licensed band. Operations in unlicensed spectrum may include downlink transmissions, uplink transmissions, or both. Duplexing in unlicensed spectrum may be based on frequency division duplexing (FDD), time division duplexing (TDD) or a combination of both.

In some cases, a UE 115 may also be able to communicate directly with other UEs (e.g., using a peer-to-peer (P2P) or device-to-device (D2D) protocol). One or more of a group of UEs 115 utilizing D2D communications may be within the coverage area 110 of a cell. Other UEs 115 in such a group may be outside the coverage area 110 of a cell, or otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out independent of a base station 105.

Some UEs 115, such as MTC or IoT devices, may be low cost or low complexity devices, and may provide for automated communication between machines, i.e., Machine-to-Machine (M2M) communication. M2M or MTC may refer to data communication technologies that allow devices to communicate with one another or a base station without human intervention. For example, M2M or MTC may refer to communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, an MTC device may operate using half-duplex (one-way) communications at a reduced peak rate. MTC devices may also be configured to enter a power saving “deep sleep” mode when not engaging in active communications. In some cases, MTC or IoT devices may be designed to support mission critical functions and wireless communications system may be configured to provide ultra-reliable communications for these functions. Wireless communications system 100 may use multiple channels, such as logical channels, transport channels, and physical layer channels, to communicate data. For example, uplink physical channels may include PUSCH Format 2 for transmission of UCI

In some cases, a wireless communications system 100 may utilize both LTE and narrowband radio access technologies. In some examples, narrowband communications may be used to serve MTC devices. Narrowband communications may use limited frequency resources, and, in some cases, may be limited to a single RB of system bandwidth (e.g., 180 kHz), a series of RBs, or portions of an RB. In some examples, the frequency resources set aside for narrowband communications may be located within an LTE carrier, in a guard band of an LTE carrier, or separate from an LTE carrier in a “standalone” deployment. In some cases, the narrowband resources may be simultaneously utilized by multiple UEs 115. The narrowband resources may be used to provide deep coverage to support devices in environments that are associated with different coverage enhancement levels. For instance, certain stationary devices may be located in environments with poor coverage, such as a basement. Additionally, the narrowband resources may be associated with communications within a large coverage area 110. Communications to a device at an edge of the coverage area 110 may have a large delay (e.g., 200 μs) in comparison to an LTE symbol time (e.g., 72 μs).

In some cases, wireless communications system 100 may utilize coverage enhancement techniques with narrowband communications to improve the quality of a communication link 125 for UEs 115 located at a cell edge, operating with low power transceivers, or experiencing high interference or path loss. Coverage enhancement techniques may include repeated transmissions, beamforming, power boosting, or other techniques. The coverage enhancement techniques used may depend on the specific needs of UEs 115 in different circumstances, and may be effective for communicating with devices that are located in areas that routinely experience poor channel conditions.

In some aspects, wireless communications system 100 may be a packet-based network that operate according to a layered protocol stack. For example, a medium access control (MAC) layer may use hybrid automatic repeat request (HARQ) schemes to provide retransmission (e.g., to improve link efficiency). HARQ may be a method of ensuring that data is received correctly over a wireless communication link 125. HARQ may include a combination of error detection (e.g., using cyclic redundancy check (CRC)), forward error check (FEC), and retransmission (e.g., using automatic repeat request (ARQ)). HARQ may improve throughput at the MAC layer in poor radio conditions (e.g., signal-to-noise conditions). In incremental redundancy (IR) HARQ, incorrectly received data may be stored in a buffer and combined with subsequent transmissions to improve the overall likelihood of successfully decoding the data. In some aspects, redundancy bits may be added to each message prior to transmission or a different set of bits may be transmitted (e.g., to combat poor radio signal conditions and exploit IR gain). In other aspects, redundancy bits are not added to each transmission, but different sets of bits are retransmitted after the transmitter of the original message receives a negative acknowledgement (NACK) indicating a failed attempt to decode the information. The chain of transmission, response and retransmission may be referred to as a HARQ process. In some aspects, a limited number of HARQ processes may be used for a given communication link 125.

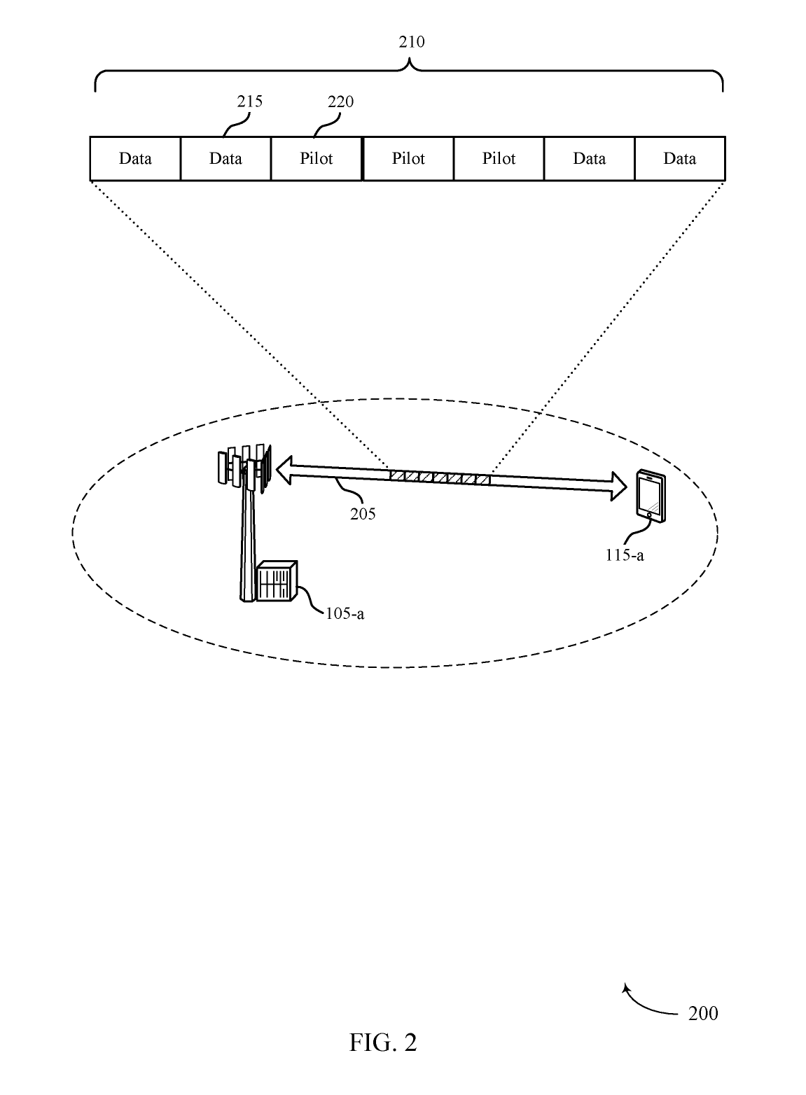

FIG. 2 illustrates an example of a wireless communications system 200 that supports narrowband uplink control in accordance with aspects of the present disclosure. Wireless communications system 200 includes a base station 105-a and UE 115-a, each of which may be an example of the corresponding device described above with reference to FIG. 1.

UE 115-a may be an example of a narrowband-capable device (e.g., an MTC device) that is operable to communicate with base station 105-a over a narrowband wireless link 205, which may be an example of a communication link 125 as described with reference to FIG. 1. In some cases, communications over narrowband wireless link 205 may be impacted by a distance between UE 115-a and base station 105-a, signal attenuation due to obstacles between UE 115-a and base station 105-a, signal interference due to other transmissions in wireless communications system 200, hardware limitations and/or power constraints at UE 115, etc.

Accordingly, base station 105-a may contain a narrowband receiver as described herein (or components thereof) to support communications with UE 115-a. In some examples, narrowband wireless link 205 may support NPUSCH Format 2 transmissions. For example, UE 115-a may transmit UCI using NPUSCH Format 2 resources over narrowband wireless link 205. In accordance with aspects of the present disclosure, base station 105-a may perform low SNR processing and CFO cancellation in order to detect and/or decode the UCI.

As described above, NPUSCH Format 2 may serve as the NB-IoT equivalent of the PUCCH in LTE. As such, it may carry UCI for a single user comprising a single bit signaled over a π/2-binary phase shift keying (BPSK) modulation scheme that spans a single subcarrier. In some examples, only 15 kHz subcarrier spacing may be supported for NPUSCH Format 2 transmissions. However, because of the low SNRs supported by NB-IoT applications, a configurable number of repetitions may be supported for a given UCI transmission. The fundamental unit of repetition may be referred to as a resource unit (RU), where each RU includes four slots 210 (e.g., with each slot 210 spanning 0.5 ms in duration). In some cases, the number of repetitions for a given UCI transmission may be determined based on a repetition factor R, where R belongs to the set {1,2,4,8,16,32,64,128}.

Each slot 210 may contain seven OFDM symbols (e.g., indexed 0 through 6). The three central symbols (e.g., indexed 2 through 4) may be reserved for reference signal (e.g., pilot) symbols 220, while the remaining symbols (e.g., indexed 0 through 1 and 5 through 6) may comprise data symbols 215. The reference signal symbols 220 may be used to facilitate decoding of the data symbols 215 (e.g., may be based on a defined sequence such that channel estimation may be performed at a receiving device).

Within each RU, the HARQ indication bit O₀^{AcK} is duplicated 15 times to yield 16 identical information bits, which are then scrambled, mapped to

$$a \frac{π}{2} - BPSK$$

modulation, and rotated (e.g., to maintain phase continuity across adjacent symbols). Each slot 210 contains four of the 16 information bits (i.e., corresponding to the data symbols 215).

In some cases, in addition to decoding the transmitted HARQ indication, a receiver may be able to maintain a maximal prescribed probability of discontinuous transmission (DTX) to ACK events. For example, the DTX to ACK probability, herein referred to as P_{FA}, may be prescribed to be lower than 10⁻². Similarly, a block error rate (BER) (e.g., or which may alternatively be referred to as missed detection) performance may be specified (e.g., may be lower than 10⁻² for a given SNR level and a given number of repetitions). Accordingly, a detection unit may be included as part of the receiver design, as described further below.

In some cases, wireless communications system 200 may support various performance requirements. For example, the maximum permissible UE frequency error may be bounded based at least in part on the BS carrier frequency. By way of example, if the carrier frequency is greater than or equal to 1 GHz, the maximum permissible UE frequency error may be ±0.2 parts per million (ppm); if the carrier frequency is less than or equal to 1 GHz, the maximum permissible UE frequency error may be ±0.1 ppm. For example, considering a maximum carrier frequency of 2.3 GHz, the maximum permissible UE frequency error (i.e., maximum frequency offset) may be 230 Hz.

It is to be understood that the numbers above are included for the sake of explanation and are not limiting of scope. Accordingly, the described techniques may be employed in wireless communications systems supporting different performance requirements.

Similarly, example equations considered in designing a narrowband receiver that supports uplink control information are described below. In some cases, similar equations or techniques may be employed to achieve the same results as various of the equations below. Thus, it is to be understood that the example equations are included for explanatory purposes and are not necessarily limiting of scope. In designing a narrowband receiver that supports uplink control information, various mathematical models may be employed.

By way of example, the m^{th} cyclic-prefixed symbol (e.g., with 0≤m<7) transmitted on the k^{th} sub-carrier (e.g., with 0≤k<12) in the l^{th} slot (e.g., with 0≤l<4R) may be given by:

$${x}_{m , l} ( t ) = β {\tilde{s}}_{m , l} {e}^{j \frac{2 π}{{T}^{′}} ( k + \frac{1}{2} ) ( t - {T}_{CP , m}^{′} )} {e}^{j 2 π {f}_{0} ( t + {τ}_{m , l} )} , 0 \leq t < {T}_{CP , m}^{′} + {T}^{′} \qquad ( 1 )$$

where:
β is the complex transmission gain (including the unknown modulator phase);
T′ is the effective symbol time, which is related to the nominal (i.e., receiver) symbol time
T by the relation

$${T}^{′} = \frac{T}{1 + {ɛ}_{T}} , where {ɛ}_{T} = \frac{Δ {f}_{T}}{{F}_{s}}$$

is the residual timing frequency offset relative to the sampling frequency;
T′_{CP,m} is the effective cyclic prefix (CP) duration in symbol index m; and
\tilde{s}_{m,l} is the effective symbol transmitted on the m^{th} symbol of the l^{th} slot, given by:

$${\tilde{s}}_{m , l} = \{ \begin{matrix}{ab}_{m , l} {e}^{j {ϕ}_{m , l}} & m = 0 , 1 , 5 , 6 \\ {r}_{m , l} {e}^{j {ϕ}_{m , l}} & m = 2 , 3 , 4\end{matrix} \qquad ( 2 )$$

where a∈[−1,1] is the data symbol 215 (i.e., ACK/NACK bit);

$$\frac{π}{2}$$

b_{m,l}∈[−1,1] is the modulated scrambling sequence (i.e., according to the BPSK modulation); and

r_{m,l}∈[−1,1] is the Demodulation Reference Signal (DMRS) (i.e., corresponding to the reference symbols 220).

The phase φ_{m,l} is given by:

$$\begin{matrix}{ϕ}_{m , l} = \frac{π}{4} + \frac{π}{2} {〈 \tilde{l} 〉}_{2} + {\tilde{ϕ}}_{\tilde{l}} & ( 3 ) \\ {\tilde{ϕ}}_{\tilde{l}} = {\tilde{ϕ}}_{\tilde{l} - 1} + \frac{2 π}{T} ( k + \frac{1}{2} ) ( T + {T}_{CP , {〈 \tilde{l} 〉}_{7}} ) & ( 4 ) \\ \tilde{l} = 7 l + m & ( 5 ) \\ {\tilde{ϕ}}_{0} = 0 & ( 6 )\end{matrix}$$

where:
f₀ is the residual CFO transmitted signal;
τ_{m,l} accounts for the time-delay between symbols, and is given by:

$${τ}_{m , l} = {\sum }_{q = 0}^{7 l + m - 1} ( {T}^{′} + {T}_{CP , {〈 q 〉}_{7}}^{′} ) \qquad ( 7 )$$

and R is the number of NPUSCH Format 2 repetitions, as introduced above.

Similar modeling may be performed for the received signal. For example, if the receiver is tuned to receive the first symbol at a timing offset Δt from the CP end, the m^{th} received symbol of the l^{th} slot received signal at the i^{th} antenna port may be written as:

$$\begin{matrix}{y}_{m , l}^{( i )} ( t ) = β {H}_{m . l}^{( i )} {\tilde{s}}_{m , l} {e}^{j \frac{2 π}{{T}^{′}} ( k + \frac{1}{2} ) ( t - Δ {t}_{m , l} )} {e}^{j 2 π {f}_{0} ( t - Δ {t}_{m , l} + {T}_{CP , m}^{′} + {τ}_{m , l} )} {e}^{j {Φ}_{i}} + {w}_{m , l}^{( i )} ( t ) , 0 \leq t < T where \text{:} & ( 8 ) \\ Δ {t}_{m , l} = Δ t - {\sum }_{q = 1}^{7 l + m} [ ( T + {T}_{CP , {〈 \tilde{l} 〉}_{7}} ) - ( {T}^{′} + {T}_{CP , {〈 q 〉}_{7}}^{′} ) ] = Δ t - \frac{{ɛ}_{T}}{1 + {ɛ}_{T}} ( {\overline{t}}_{7 l + m} - {T}_{CP , 0} ) & ( 9 ) \\ {\overline{t}}_{7 l + m} = {\sum }_{q = 0}^{7 l + m - 1} ( T + {T}_{CP , {〈 q 〉}_{7}} ) + {T}_{CP , m} & ( 10 )\end{matrix}$$

where:
t̅ᵤ̅ denotes the time-period from the start of the NPUSCH transmission to the beginning of the u^{th} symbol (i.e., post-CP), using the nominal (i.e., receiver) clock rate; H_{m,l}⁽ⁱ⁾, is the i^{th} antenna channel frequency response at the transmitted tone frequency, where the channel impulse response is non-zero only in the range

$$0 \leq t < min \{ {T}_{CP , 0} - Δ t , {T}_{CP , 6} - ( Δ t - \frac{{ɛ}_{T}}{1 + {ɛ}_{T}} ( {\overline{t}}_{28 R} - {T}_{CP , 0} ) ) \}$$

and w_{m,l}⁽ⁱ⁾(t) denotes noise and/or interference impinging on the i^{th} antenna.

Eq. 8 may be valid only as long as the initial symbol boundary does not exceed the CP. From Eq. 9, it may be shown that this condition holds for the entire NPUSCH transmission provided that:

$$Δ t , {T}_{CP , 6} < \frac{{ɛ}_{T}}{1 + {ɛ}_{T}} ( {\overline{t}}_{28 , R} - {T}_{CP , 0} ) < Δ t \qquad ( 11 )$$

or equivalently:

$$\frac{Δ t - {T}_{CP , 6}}{{\overline{t}}_{28 R} - {T}_{CP , 0} - Δ t + {T}_{CP , 6}} < {ɛ}_{T} < \frac{Δ t}{( {\overline{t}}_{28 R} - {T}_{CP , 0} - Δ t )} \qquad ( 12 )$$

In some cases, it may be useful to set a symmetric upper bound, such that the condition for not exceeding the CP limits may be given by:

$$\vert {ɛ}_{T} \vert < min \{ \frac{Δ t}{( {\overline{t}}_{28 R} - {T}_{CP , 0} - Δ t )} , \frac{{T}_{CP , 6} - Δ t}{{\overline{t}}_{28 R} - {T}_{CP , 0} - Δ t + {T}_{CP , 6}} \} \qquad ( 13 )$$

In some cases, the upper bound on ε_{T} may be modeled as a function of the number of repetitions for a timing backoff Δt=1 μs. Under this scenario, in order to ensure valid operation across the maximal number of repetitions without digital compensation, the residual timing offset may be restricted to being lower than 3.9 ppm. Otherwise, a digital timing offset compensation mechanism may be introduced.

The equivalent discrete-time signal, obtained by sampling the continuous-time signal in Eq. 8 at rate Fₛ is given by:

$${y}_{m , l}^{( i )} [ n ] = β {e}^{j {Φ}_{i}} {H}_{m , l}^{( i )} {\tilde{s}}_{m , l} {e}^{j \frac{2 π}{N} ( k + \frac{1}{2} ) ( 1 + {ɛ}_{T} ) n} {e}^{- j \frac{2 π}{{T}^{′}} ( k + \frac{1}{2} ) Δ {t}_{m , l}} {e}^{j 2 π \frac{{f}_{0}}{{F}_{s}} ( n - {F}_{s} Δ {t}_{m , l} + {F}_{s} {T}_{CP , m}^{′} + {F}_{s} {τ}_{m , l} )} + {w}_{m , l}^{( i )} [ n ] , 0 \leq n < N \qquad ( 14 )$$

where

$$N = \frac{{F}_{s}}{Δ f} and Δ f = \frac{1}{T} .$$

Following half subcarrier shift removal, the obtained signal may be written as:

$${y}_{m , l}^{( i )} [ n ] = β {e}^{j {Φ}_{i}} {H}_{m , l}^{( i )} {\tilde{s}}_{m , l} {e}^{j \frac{2 π}{N} k ( 1 + {ɛ}_{T} ) n} {e}^{j \frac{π}{N} {ɛ}_{T} n} {e}^{- j \frac{2 π}{{T}^{′}} ( k + \frac{1}{2} ) Δ {t}_{m , l}} {e}^{j 2 π \frac{{f}_{0}}{{F}_{s}} ( n - {F}_{s} Δ {t}_{m , l} + {F}_{s} {T}_{CP , m}^{′} + {F}_{s} {τ}_{m , l} )} + {w}_{m , l}^{( i )} [ n ] , 0 \leq n < N \qquad ( 15 )$$

or, equivalently:

$$\begin{matrix}\begin{matrix}{y}_{m , l}^{( i )} [ n ] = β {e}^{j {Φ}_{i}} {H}_{m , l}^{( i )} {\tilde{s}}_{m , l} {e}^{j \frac{2 π}{N} {ɛ}_{T} n} {e}^{j \frac{2 π}{N} kn} {e}^{j 2 π ( \frac{( 2 k + 1 ) {ɛ}_{T}}{2 N} + \frac{{f}_{0}}{{F}_{s}} ) n} \\ {e}^{- j2 π ( Δ f ( 1 + {ɛ}_{T} ) ( k + \frac{1}{2} ) Δ {t}_{m , l} + {f}_{0} ( Δ {t}_{m , l} - {T}_{CP , m}^{′} - {τ}_{m , l} ) )} + {w}_{m , l}^{( i )} [ n ] \\ = β {e}^{j {Φ}_{i}} {H}_{m , l}^{( i )} {\tilde{s}}_{m , l} {e}^{j \frac{2 π}{N} kn} {e}^{j 2 π \frac{{\overline{f}}_{0}}{{F}_{s}} n} {e}^{- j {φ}_{m , l}} + {w}_{m , l}^{( i )} [ n ]\end{matrix} \\ where \text{:} & ( 16 ) \\ {\overline{f}}_{0} = {f}_{0} + Δ f ( k + \frac{1}{2} ) {ɛ}_{T} & ( 17 ) \\ {\tilde{φ}}_{m , l} = 2 π ( Δ f ( 1 + {ɛ}_{T} ) ( k + \frac{1}{2} ) Δ {t}_{m , l} + {f}_{0} ( Δ {t}_{m , l} - {T}_{CP , m}^{′} - {τ}_{m , l} ) ) & ( 18 )\end{matrix}$$

Substituting the expression for Δt_{m,l} in Eq. 9 into Eq. 18, yields:

$$\begin{matrix} {\tilde{φ}}_{m , l} = 2 π ( Δ f ( 1 + {ɛ}_{T} ) ( k + \frac{1}{2} ) ( Δ t + \frac{{ɛ}_{T} {T}_{CP , 0}}{1 + {ɛ}_{T}} ) + {f}_{0} ( Δ t + \frac{{ɛ}_{T}}{1 + {ɛ}_{T}} {T}_{CP , 0} ) ) - 2 π {\overline{f}}_{0} {\overline{t}}_{7 l + m} where \text{:} & ( 19 ) \\ {τ}_{m , l} + {T}_{CP , m}^{′} = \frac{{\overline{t}}_{7 l + m}}{1 + {ɛ}_{T}} & ( 20 )\end{matrix}$$

Substituting the result of Eq. 19 into Eq. 16, yields:

$$\begin{matrix} {y}_{m , l}^{( i )} [ n ] = {B}_{i} {H}_{m , l}^{( i )} {\tilde{s}}_{m , l} {e}^{j \frac{2 π}{N} kn} {e}^{j 2 π \frac{{\overline{f}}_{0}}{{F}_{s}} n} {e}^{j {φ}_{m , l}} + {w}_{m , l}^{( i )} [ n ] \\ where \text{:} & ( 21 ) \\ {B}_{i} = β {e}^{j {\tilde{Φ}}_{i}} & ( 22 ) \\ {\tilde{Φ}}_{i} = {Φ}_{i} - 2 π ( Δ f ( 1 + {ɛ}_{T} ) ( k + \frac{1}{2} ) ( Δ t + \frac{{ɛ}_{T} {T}_{CP , 0}}{1 + {ɛ}_{T}} ) + {f}_{0} ( Δ t + \frac{{ɛ}_{T}}{1 + {ɛ}_{T}} {T}_{CP , 0} ) ) & ( 23 ) \\ {φ}_{m , l} = 2 π {\overline{f}}_{0} {\overline{t}}_{7 l + m} & ( 24 )\end{matrix}$$

In some cases the communication channel may be modeled using a channel impulse response comprising discrete taps, each of which may be an independent Gaussian random variable (RV). Accordingly, each channel frequency response may be modeled as a Gaussian RV. With respect to channel fading characteristics, the Doppler spread encountered in a narrowband communication link may be approximately 5 Hz. Because of a strong correlation between frequency response and time (e.g., using Jakes' Model), the channel may be relatively constant across a slot 210.

As described above, a receiver in accordance with the present disclosure may be operable to perform ACK/NACK decoding as well as signal detection. These operations are described in turn below. ACK/NACK decoding may include demodulation of a received signal and application of a decoder (e.g., a maximum-likelihood (ML) decoder). Considering the practical model that includes frequency offset and timing offset, the received signal may be given by Eq. 21, which is repeated here for convenience:

$$\begin{matrix}{y}_{m , l}^{( i )} [ n ] = {B}_{i} {H}_{m , l}^{( i )} {\tilde{s}}_{m , l} {e}^{j \frac{2 π}{N} kn} {e}^{j 2 π \frac{\overline{{f}_{0}}}{{F}_{s}} n} {e}^{j {φ}_{m , l}} + {w}_{m , l}^{( i )} [ n ] \\ where \text{:} & ( 25 ) \\ {φ}_{m , l} = 2 π {\overline{f}}_{0} {\overline{t}}_{7 l + m} & ( 26 )\end{matrix}$$

and all other quantities are defined as above.

Following an N-point discrete Fourier transform (DFT), the following signal at subcarrier index k may be obtained:

$${\tilde{Y}}_{m , l}^{( i )} = {\sum }_{n = 0}^{N - 1} {y}_{m , l}^{( i )} [ n ] {e}^{- j \frac{2 π}{N} kn} = {B}_{i} {H}_{m , l}^{( i )} {\tilde{s}}_{m , l} {e}^{j {φ}_{m , l}} {\sum }_{n = 0}^{N - 1} {e}^{j 2 π \frac{{\overline{f}}_{0}}{{F}_{s}} n} + {\tilde{W}}_{m , l}^{( i )} = {B}_{i} {H}_{m , l}^{( i )} {\tilde{s}}_{m , l} {e}^{j {φ}_{m , l}} {e}^{j π \frac{{\overline{f}}_{0}}{{F}_{s}} ( N - 1 )} N \cdot {D}_{N} ( 2 π \frac{{\overline{f}}_{0}}{{F}_{s}} ) + {\tilde{W}}_{m , l}^{( i )} \qquad ( 27 )$$

where \tilde{W}_{m,l}⁽ⁱ⁾ is the DFT of w_{m,l}⁽ⁱ⁾[n] at sub-carrier index k and D_{N}(x) denotes the Dirichlet function with parameter N.

Descrambling and de-rotation of the modulated symbols yields:

$$\begin{matrix}{Y}_{m , l}^{( i )} = \{ \begin{matrix}{\tilde{Y}}_{m , l}^{( i )} {b}_{m , l} {e}^{- j {ϕ}_{m , l}} & m = 0 , 1 , 5 , 6 \\ {\tilde{Y}}_{m , l}^{( i )} {r}_{m , l} {e}^{- j {ϕ}_{m , l}} & m = 2 , 3 , 4\end{matrix} = {H}_{l}^{( i )} {s}_{m} {e}^{j {φ}_{m , l}} + {W}_{m , l}^{( i )} where \text{:} & ( 28 ) \\ {H}_{l}^{( i )} = {NB}_{i} {H}_{m , l}^{( i )} {D}_{N} ( 2 π \frac{{\overline{f}}_{0}}{{F}_{s}} ) {e}^{j 2 π \frac{{\overline{f}}_{0}}{{F}_{s}} ( N - 1 )} & ( 29 ) \\ {s}_{m} = \{ \begin{matrix}a & m = 0 , 1 , 5 , 6 \\ 1 & m = 2 , 3 , 4\end{matrix} & ( 30 )\end{matrix}$$

In some cases, the dependence of the channel response on m may be omitted (e.g., based on the channel model as described above).

By summing the data symbols 215 and RS symbols 220 separately within each slot 210, the following model may be obtained:

$$\begin{matrix} y = {[ {y}_{1}^{T} {y}_{2}^{T} ]}^{T} & ( 31 ) \\ {y}_{i} = {[ {d}_{i}^{T} {r}_{i}^{T} ]}^{T} & ( 32 ) \\ {d}_{i} = {G}_{d} ( {\tilde{h}}_{i} ∘ p ) a + {v}_{i} & ( 33 ) \\ {r}_{i} = {G}_{r} ( {\tilde{h}}_{i} ∘ p ) + {w}_{i} & ( 34 ) \\ {\tilde{h}}_{i} = {[ {H}_{0}^{( i )} {H}_{1}^{( i )} … {H}_{4 R - 1}^{( i )} ]}^{T} & ( 35 ) \\ {v}_{i} = {[ {v}_{i , 1} {v}_{i , 2} … {v}_{i , 4 R - 1} ]}^{T} & ( 36 ) \\ {w}_{i} = {[ {w}_{i , 1} {w}_{i , 2} … {w}_{i , 4 R - 1} ]}^{T} & ( 37 ) \\ {v}_{i , l} = \frac{1}{4} {\sum }_{m = \{ 0 , 1 , 5 , 6 \}}^{ } {W}_{m , l}^{( i )} & ( 38 ) \\ {w}_{i , l} = \frac{1}{3} {\sum }_{m = \{ 2 , 3 , 4 \}}^{ } {W}_{m , l}^{( i )} & ( 39 ) \\ {G}_{d} = \frac{1}{2} [ cos ( 6 π {\overline{f}}_{0} ( T + {T}_{CP , 1} ) ) + cos ( 4 π {\overline{f}}_{0} ( T + {T}_{CP , 1} ) ) ] {e}^{j 6 π {\overline{f}}_{0} ( T + {T}_{CP , 1} )} & ( 40 ) \\ {G}_{r} = \frac{2}{3} [ cos ( 2 π {\overline{f}}_{0} ( T + {T}_{CP , 1} ) ) + \frac{1}{2} ] {e}^{j 6 π \overline{{f}_{0}} ( T + {T}_{CP , 1} )} & ( 41 ) \\ {p}_{l} = {e}^{j ω i} & ( 42 ) \\ ω = 2 π \overline{{f}_{0}} {T}_{slot} & ( 43 )\end{matrix}$$

It thus follows that {vᵢ}, {wᵢ} are mutually independent Gaussian vectors with covariance matrices:

$$\begin{matrix}{C}_{{v}_{i} {v}_{i}} = \frac{{σ}_{w}^{2}}{4} I & ( 44 ) \\ {C}_{{w}_{i} {w}_{i}} = \frac{{σ}_{w}^{2}}{3} I & ( 45 )\end{matrix}$$

and {hᵢ} are independent Gaussian vectors with a common covariance matrix Cₕₕ defined by the channel's delay profile and Doppler spread.

In some cases, the dependence of G_{d}, Gᵣ on f̅₀̅ may be weak for frequency offsets up to 250 Hz (e.g., amounting to up to 0.35 dB degradation). Thus, in order to simplify calculations, the following approximations may be:

$$\begin{matrix}{d}_{i} \approx ( {h}_{i} ∘ p ) a + {v}_{i} & ( 46 ) \\ {r}_{i} \approx ( {h}_{i} ∘ p ) + {w}_{i} & ( 47 ) \\ {h}_{i} = {{e}^{j 6 π {\overline{f}}_{0} ( T + {T}_{CP , 1} )} [ {H}_{0}^{( i )} {H}_{1}^{( i )} … {H}_{4 R - 1}^{( i )} ]}^{T} & ( 48 )\end{matrix}$$

The maximum a posteriori (MAP) estimator of the transmitted HARQ symbol a may be given by:

$${\hat{a}}_{ML} = {argmax}_{a} \{ {max}_{ω ∈ Ω} \{ f ( a \vert y ) \} \} = {argmax}_{a} \{ {max}_{ω ∈ Ω} \{ f ( y \vert a ) \} \} \qquad ( 49 )$$

where equal a-priori probabilities for a are assumed and Ω denotes the valid range of frequencies.

In order to further simplify the calculations, the noises across the antennas may be modeled as having equal power and may be uncorrelated. That is:

E{|W_{m,l}⁽ⁱ⁾|²}=σ² (50)

Cᵥ_{₁}ᵥ_{₂}=0·I (51)

C_{w}_{₁}_{w}_{₂}==0·I (52)

Using these simplifications, the following relationships may be developed:

$$\begin{matrix} {C}_{yy \vert a} = E \{ {yy}^{H} \vert a \} = [ \begin{matrix}{C}_{{y}_{1} {y}_{1} \vert a} & 0 \\ 0 & {C}_{{y}_{2} {y}_{2} \vert a}\end{matrix} ] \\ {C}_{{y}_{i} {y}_{i} \vert a} = [ \begin{matrix}{C}_{hh} ∘ {pp}^{H} + \frac{{σ}^{2}}{4} I & {aC}_{hh} ∘ {pp}^{H} \\ {aC}_{hh} ∘ {pp}^{H} & {C}_{hh} ∘ {pp}^{H} + \frac{{σ}^{2}}{3} I\end{matrix} ] \\ det ( {C}_{yy \vert a} ) = {det ( {C}_{{y}_{i} {y}_{i} \vert a} )}^{2} \\ det ( {C}_{{y}_{i} {y}_{i} \vert a} ) = det ( ( {C}_{hh} ∘ {pp}^{H} + \frac{{σ}^{2}}{4} I ) ( {C}_{hh} ∘ {pp}^{H} + \frac{{σ}^{2}}{3} I ) - ( {C}_{hh} ∘ {pp}^{H} ) ( {C}_{hh} ∘ {pp}^{H} ) ) = det ( \frac{7 {σ}^{2}}{12} {C}_{hh} ∘ {pp}^{H} + \frac{{σ}^{2}}{4} I ) = det ( {D}_{p} ( \frac{7 {σ}^{2}}{12} {C}_{hh} + \frac{{σ}^{2}}{12} I ) {D}_{p}^{H} ) = det ( \frac{7 {σ}^{2}}{12} {C}_{hh} + \frac{{σ}^{4}}{12} I ) where \text{:} & \\ {D}_{p} = diag \{ p \} & ( 53 )\end{matrix}$$

Accordingly, det(C_{yy|a}) may be shown to be neither a function of a nor of f̅₀̅. Therefore:

$$\begin{matrix} {\hat{a}}_{ML} = {argmin}_{a} \{ {min}_{ω ∈ Ω} \{ {y}^{H} {C}_{yy \vert a}^{- 1} y \} \} \\ {C}_{yy \vert a}^{- 1} = [ \begin{matrix}{C}_{{y}_{1} {y}_{1} \vert a}^{- 1} & 0 \\ 0 & {C}_{{y}_{2} {y}_{2} \vert a}^{- 1}\end{matrix} ] & ( 54 ) \\ {y}^{H} {C}_{{y}_{1} {y}_{1} \vert a}^{- 1} y = {y}_{1}^{H} {C}_{{y}_{1} {y}_{1} \vert a}^{- 1} {y}_{1} + {y}_{2}^{H} {C}_{{y}_{2} {y}_{2} \vert a}^{- 1} {y}_{2} \\ {C}_{{y}_{i} {y}_{i} \vert a} = [ \begin{matrix}{C}_{hh} ∘ {pp}^{H} + \frac{{σ}^{2}}{4} I & {aC}_{hh} ∘ {pp}^{H} \\ {aC}_{hh} ∘ {pp}^{H} & {C}_{hh} ∘ {pp}^{H} + \frac{{σ}^{2}}{3} I\end{matrix} ] = [ \begin{matrix}\tilde{U} Λ {\tilde{U}}^{H} + \frac{{σ}^{2}}{4} I & a \tilde{U} Λ {\tilde{U}}^{H} \\ a \tilde{U} Λ {\tilde{U}}^{H} & \tilde{U} Λ {\tilde{U}}^{H} + \frac{{σ}^{2}}{3} I\end{matrix} ] where \text{:} & ( 55 ) \\ \tilde{U} = {D}_{p} U \\ {C}_{{y}_{i} {y}_{i} \vert a}^{- 1} = [ \begin{matrix}\tilde{U} & 0 \\ 0 & \tilde{U}\end{matrix} ] [ \begin{matrix}Λ + \frac{{σ}^{2}}{4} I & a Λ \\ a Λ & Λ + \frac{{σ}^{2}}{3} I\end{matrix} ] [ \begin{matrix}{\tilde{U}}^{H} & 0 \\ 0 & {\tilde{U}}^{H}\end{matrix} ] & ( 56 ) \\ V = {[ \begin{matrix}Λ + \frac{{σ}^{2}}{4} I & a Λ \\ a Λ & Λ + \frac{{σ}^{2}}{3} I\end{matrix} ]}^{- 1} & ( 57 ) \\ \begin{matrix}{V}_{11} = {( Λ + \frac{{σ}^{2}}{4} I )}^{- 1} + {( Λ + \frac{{σ}^{2}}{4} I )}^{- 1} \\ a {Λ [ ( Λ + \frac{{σ}^{2}}{3} I ) - a {Λ ( Λ + \frac{{σ}^{2}}{4} I )}^{- 1} a Λ ]}^{- 1} a {Λ ( Λ + \frac{{σ}^{2}}{4} I )}^{- 1} \\ = \frac{12}{{σ}^{2}} ( Λ + \frac{{σ}^{2}}{3} I ) {( 7 Λ + {σ}^{2} I )}^{- 1}\end{matrix} & ( 58 ) \\ {V}_{12} = {V}_{21} = - {( Λ + \frac{{σ}^{2}}{4} I )}^{- 1} a {Λ [ ( Λ + \frac{{σ}^{2}}{3} I ) - {{Λ}^{2} ( Λ + \frac{{σ}^{2}}{4} I )}^{- 1} ]}^{- 1} = - a Λ {\frac{12}{{σ}^{2}} [ 7 Λ + {σ}^{2} I ]}^{- 1} & ( 59 ) \\ {V}_{22} = {[ ( Λ + \frac{{σ}^{2}}{3} I ) - {{Λ}^{2} ( Λ + \frac{{σ}^{2}}{4} I )}^{- 1} ]}^{- 1} & ( 60 )\end{matrix}$$

Accordingly, only the off-block-diagonal matrices depend on the optimizing parameters. Thus, Eq. 55 may be written as follows:

$$\begin{matrix}\begin{matrix}{y}^{H} {C}_{yy \vert a}^{- 1} y = {\tilde{y}}_{1}^{H} V {\tilde{y}}_{1} + {\tilde{y}}_{2}^{H} V {\tilde{y}}_{2} \\ = {\sum }_{i = 1}^{2} {\tilde{d}}_{i}^{H} {V}_{11} {\tilde{d}}_{i} + {\tilde{d}}_{i}^{H} {V}_{12} {\tilde{r}}_{i} + {\tilde{r}}_{i}^{H} {V}_{21} {\tilde{d}}_{i} + {\tilde{r}}_{i}^{H} {V}_{22} {\tilde{r}}_{i} \\ = {\sum }_{i = 1}^{2} {d}_{i}^{H} \tilde{U} {V}_{11} {\tilde{U}}^{H} {d}_{i} + {d}_{i}^{H} \tilde{U} {V}_{12} {\tilde{U}}^{H} {r}_{i} + {r}_{i}^{H} \tilde{U} {V}_{21} {d}_{i} + \\ {r}_{i}^{H} \tilde{U} {V}_{22} {\tilde{U}}^{H} {r}_{i}\end{matrix} \\ where \text{:} & ( 61 ) \\ {\tilde{y}}_{i} = [ \begin{matrix}{\tilde{U}}^{H} & 0 \\ 0 & {\tilde{U}}^{H}\end{matrix} ] {y}_{i} \\ Thus \text{:} & ( 62 ) \\ {\hat{a}}_{ML} = {argmin}_{a} \{ {min}_{ω ∈ Ω} \{ {\sum }_{i = 1}^{2} {d}_{i}^{H} \tilde{U} {V}_{11} {\tilde{U}}^{H} {d}_{i} - 2 a Re {\{ {d}_{i}^{H} \tilde{U} {\overline{V}}_{12} {\tilde{U}}^{H} r \}}_{i} + {r}_{i}^{H} \tilde{U} {V}_{22} {\tilde{U}}^{H} {r}_{i} \} \} where \text{:} & ( 63 ) \\ {\overline{V}}_{12} = \frac{12}{{σ}^{2}} {Λ [ 7 Λ + {σ}^{2} I ]}^{- 1} & ( 64 )\end{matrix}$$

In some cases, the following operations may be used to develop an approximate solution to Eq. 63 (e.g., because there may not be a closed-form solution to Eq. 63).

For example, a normalized maximum likelihood (NML) decoder may be developed as follows. In order to obtain an expression in the frequency domain, the following approximation may be introduced:

FCₕₕF^{H}≈S (65)

where S is a sparse matrix with non-zero elements spanning only the main diagonal, which correspond to the Doppler spectrum.

Eq. 63 may be written as follows:

$${\hat{a}}_{ML} = {argmin}_{a} \{ {min}_{ω ∈ Ω} \{ {\sum }_{i = 1}^{2} {d}_{i}^{H} {D}_{p} \tilde{U} {V}_{11} {\tilde{U}}^{H} {D}_{p}^{H} {d}_{i} - 2 a Re {\{ {d}_{i}^{H} {D}_{P} \tilde{U} {\overline{V}}_{12} {\tilde{U}}^{H} {D}_{p}^{H} r \}}_{i} + {r}_{i}^{H} {D}_{p} \tilde{U} {V}_{22} {\tilde{U}}^{H} {D}_{p}^{H} {r}_{i} \} \} \qquad ( 66 )$$

and the following definitions may be introduced:

$$\begin{matrix}{S}_{11} = \frac{12}{{σ}^{2}} ( S + \frac{{σ}^{2}}{3} I ) {( 7 S + {σ}^{2} I )}^{- 1} & ( 67 ) \\ {S}_{12} = \frac{12}{{σ}^{2}} {S [ 7 S + {σ}^{2} I ]}^{- 1} & ( 68 ) \\ {S}_{22} = \frac{12}{{σ}^{2}} ( S + \frac{{σ}^{2}}{4} I ) {( 7 S + {σ}^{2} I )}^{- 1} & ( 69 )\end{matrix}$$

By using the approximation in Eq. 65 and the above definitions, the ML solution may be approximated as follows:

$$\begin{matrix}{\hat{a}}_{ML} = {argmin}_{a} \{ {min}_{ω ∈ Ω} \{ {\sum }_{i = 1}^{2} {d}_{i}^{H} {D}_{p} {F}^{H} {S}_{11} {FD}_{p}^{H} {d}_{i} - 2 a Re \{ {d}_{i}^{H} {D}_{P} {F}^{H} {S}_{12} {FD}_{p}^{H} {r}_{i} \} + {r}_{i}^{H} {D}_{p} {F}^{H} {S}_{22} {FD}_{p}^{H} {r}_{i} \} \} \\ or , equivalently : & ( 70 ) \\ {\hat{a}}_{ML} = {argmin}_{a} \{ {min}_{ω ∈ Ω} \{ {\sum }_{i = 1}^{2} {d}_{i}^{H} {D}_{p} {F}^{H} {\hat{S}}_{11} {FD}_{p}^{H} {d}_{i} - 2 a Re \{ {d}_{i}^{H} {D}_{P} {F}^{H} {\hat{S}}_{12} {FD}_{p}^{H} {r}_{i} \} + {r}_{i}^{H} {D}_{p} {F}^{H} {\hat{S}}_{22} {FD}_{p}^{H} {r}_{i} \} \} & ( 71 )\end{matrix}$$

where Ŝᵢⱼ denotes the square (diagonal) matrix of smallest dimensions that contains all the non-zero elements in Sᵢⱼ, and FFT shifting is implicitly assumed.

Since all elements in Ŝᵢⱼ are greater than zero, Eq. 70-71 may be written as:

$${\hat{a}}_{ML} = {argmin}_{a} \{ {min}_{ω ∈ Ω} \{ {\sum }_{i = 1}^{2} {‖ \sqrt{{\hat{S}}_{11}} {FD}_{p}^{H} {d}_{i} ‖}^{2} + {‖ \sqrt{{\hat{S}}_{22}} {FD}_{p}^{H} {r}_{i} ‖}^{2} - 2 a Re \{ {( \sqrt{{\hat{S}}_{12}} {FD}_{p}^{H} {d}_{i} )}^{H} ( \sqrt{{\hat{S}}_{12}} {FD}_{p}^{H} {r}_{i} ) \} \} \} \qquad ( 72 )$$

It is to be noted that the argument in the exact ML expression (e.g., in Eq. 63) is guaranteed to be non-negative, and the optimization is based on subtraction of two terms that are guaranteed to constitute the minimum at the optimal point. However, due to the approximation in Eq. 65, these conditions are no longer guaranteed in Eq. 72, which degrades receiver performance. To address this problem, the sign of the real term is inverted to create a closely-related argument that involves maximization rather than minimization:

$${\hat{a}}_{ML} = {argmin}_{a} \{ {max}_{ω ∈ Ω} \{ {\sum }_{i = 1}^{2} {‖ \sqrt{{\hat{S}}_{11}} {FD}_{p}^{H} {d}_{i} ‖}^{2} + {‖ \sqrt{{\hat{S}}_{22}} {FD}_{p}^{H} {r}_{i} ‖}^{2} + 2 a Re \{ {( \sqrt{{\hat{S}}_{12}} {FD}_{p}^{H} {d}_{i} )}^{H} ( \sqrt{{\hat{S}}_{12}} {FD}_{p}^{H} {r}_{i} ) \} \} \} \qquad ( 73 )$$

It is further to be noted that the operator FDₚ^{H} is equivalent to the discrete time Fourier transform (DTFT) at Fourier frequencies shifted by ω. Thus, the operation \sqrt{Ŝᵢⱼ}FDₚ^{H} may be approximated by an FFT operation followed by correlation. Eq. 73 may therefore be approximated by:

$$\begin{matrix}{\hat{a}}_{NML} = {arg max}_{a} \{ {max}_{\vert k \vert \leq K} \{ {g}_{11} [ k ] * \overline{d} [ k ] + {g}_{22} [ k ] * \overline{r} [ k ] + 2 a Re \{ {g}_{12} [ k ] * ( {\sum }_{i = 1}^{2} {{d}_{i} [ k ]}^{*} {r}_{i} [ k ] ) \} \} \} & ( 74 ) \\ where \text{:} & \\ {d}_{i} [ k ] = {\sum }_{n = 0}^{{N}_{d} - 1} {d}_{i} [ n ] {e}^{- j \frac{2 π}{{N}_{d}} kn} & ( 75 ) \\ {r}_{i} [ k ] = {\sum }_{n = 0}^{{N}_{d} - 1} {r}_{i} [ n ] {e}^{- j \frac{2 π}{{N}_{d}} kn} & ( 76 ) \\ \overline{d} [ k ] = {\vert {d}_{1} [ k ] \vert}^{2} + {\vert {d}_{2} [ k ] \vert}^{2} & ( 77 ) \\ \overline{r} [ k ] = {\vert {r}_{1} [ k ] \vert}^{2} + {\vert {r}_{2} [ k ] \vert}^{2} & ( 78 ) \\ {g}_{ij} [ k ] = {\hat{S}}_{ij} [ \frac{{N}_{d}}{2} - k + 1 , \frac{{N}_{d}}{2} - k + 1 ] & ( 79 ) \\ {N}_{d} = {2}^{⌈ - {log}_{2} ( {T}_{slot} {f}_{res} ) ⌉} & ( 80 )\end{matrix}$$

where

$$- \frac{{N}_{d}}{2} \leq k < \frac{{N}_{d}}{2} - 1$$

and fᵣₑₛ is the desired frequency resolution (in Hz). Eq. 79 is valid only for values of k that do not exceed the dimensions of Ŝᵢⱼ.

Referring to Eq. 65, it is to be noted that:

$$S [ k , k ] \approx 4 R \cdot {σ}_{H}^{2} S ( \frac{2 π}{{N}_{d}} k ) \qquad ( 81 )$$

where σ_{H}² is the total channel power and S(ω) is the (normalized) Doppler spectrum, which we assume to correspond to the classic Jakes' spectrum:

$$S ( ω ) = \{ \begin{matrix}\frac{2}{{ω}_{d} \sqrt{1 - ( \frac{ω}{{ω}_{d}} )}} & \vert ω \vert < {ω}_{d} \\ 0 & o . w .\end{matrix} \qquad ( 82 )$$

with ω_{d}=2πf_{d}Tₛₗₒₜ and where f_{d} is the Doppler frequency.

Based on Eq. 81-82, the following lower-bound may be established:

$$S [ k , k ] \geq 4 R \cdot {σ}_{H}^{2} S ( 0 ) = \frac{4 R \cdot {σ}_{H}^{2}}{π {f}_{d} {T}_{slot}} \qquad ( 83 )$$

which may be rewritten as:

$$\frac{S [ k , k ]}{{σ}_{w}^{2}} \geq \frac{4 R \cdot {σ}_{H}^{2}}{{σ}_{w}^{2} π {f}_{d} {T}_{slot}} = \frac{4 R \cdot SNR}{π {f}_{d} {T}_{slot}} >> 1 \qquad ( 84 )$$

considering a maximal Doppler frequency of 5 Hz and the sensitivity SNR per repetition.

Thus, the following approximation may be invoked:

$${\hat{S}}_{11} \approx {\hat{S}}_{22} \approx {\hat{S}}_{12} \approx \frac{12}{7 {σ}^{2}} I \qquad ( 85 )$$

Using this approximation, Eq. 74 may be significantly reduced to the following expression, which may be referred to as a Simplified NML decoder herein:

$${\hat{a}}_{SNML} = {arg max}_{a} \{ {max}_{\vert k \vert \leq K} \{ Π [ k ] * ( {\sum }_{i = 1}^{2} {\vert {d}_{i} [ k ] a + {r}_{i} [ k ] \vert}^{2} ) \} \} \qquad ( 86 )$$

where Π[k] denotes the discrete rectangular pulse function given by:

$$Π [ k ] = \{ \begin{matrix}1 & \vert k \vert \leq {N}_{W} \\ 0 & o . w .\end{matrix} \qquad ( 87 )$$

where the one-sided pulse length is given by:

N_{W}=rnd(f_{d}TₛₗₒₜN_{d}) (88)

In some cases, a default decoder configuration may be enabled for a given repetition factor R. For example, when R<64, f_{d}=0 Hz (i.e., where f_{d} refers to the Doppler spread of the channel) and when R≥64, f_{d}=5 Hz. That is, in some cases (e.g., R<64) a static decoder configuration may be employed without degrading performance (e.g., in additive white Gaussian noise (AWGN) or in the Extended Pedestrian A (EPA5) fading model). In other cases (e.g., R≥64), configuring the decoder by default to EPA5 may be preferable (e.g., albeit with some associated degradation under AWGN).

In general, the larger the FFT size, the better the frequency resolution. However, the required frequency accuracy diminishes with the number of repetitions (i.e., the two are inversely proportional). Accordingly, the required FFT size may be determined in some cases per repetition based on impact performance. For example, Table 1 may be used to indicate the (approximate) FFT size for a given number of repetitions:

| Repetitions | FFT Size |
|---|---|
| 1 | 8 |
| 2 | 16 |
| 4 | 32 |
| 8 | 64 |
| 16 | 128 |
| 32 | 256 |
| 64 | 512 |
| 128 | 1024 |

As described above, in some cases a narrowband receiver in accordance with the present disclosure may additionally or alternatively be operable to perform signal detection. In some examples (e.g., to simplify detector implementation), some values calculated for the sake of the decoder may be reused (e.g., in a receiver that performs both detection and decoding). By way of example, the following detection rule may be used based at least in part on the expression for the NML decoder in Eq. 86:

$${max}_{a , \vert k \vert \leq K} \{ Π [ k ] * ( {\sum }_{i = 1}^{2} {\vert {d}_{i} [ k ] a + {r}_{i} [ k ] \vert}^{2} ) \} > λ \qquad ( 89 )$$

where Π[k] was defined in Eq. 87.

If the receiver is not configured for Doppler spread (i.e., N_{W}=0), the decision rule in Eq. 89 reduces to the following:

$${max}_{a , \vert k \vert \leq K} \{ {\sum }_{i = 1}^{2} {\vert {d}_{i} [ k ] a + {r}_{i} [ k ] \vert}^{2} \} > λ \qquad ( 90 )$$

In some cases (e.g., as described above), this argument attains near-optimal performance even in the presence of Doppler spread up to 5 Hz for R<64.

For the sake of explanation, it is to be understood that N_{d}=4R, such that no zero-padding is performed in the FFT calculation. Although zero-padding may in some cases be employed, the described techniques are still valid due to the high correlation between the FFT samples.

Under the above assumption, the sequences {dᵢ[k]} and {rᵢ[k]} are mutually independent with:

$$\begin{matrix}E \{ {\vert {d}_{i} [ k ] \vert}^{2} \} = \frac{{\tilde{σ}}_{w}^{2}}{4} & ( 91 ) \\ E \{ {\vert {r}_{i} [ k ] \vert}^{2} \} = \frac{{\tilde{σ}}_{w}^{2}}{3} & ( 92 ) \\ {\tilde{σ}}_{w}^{2} = {σ}_{w}^{2} 4 R & ( 93 ) \\ y = vec ( [ \begin{matrix}{y}_{1}^{T} \\ {y}_{- 1}^{T}\end{matrix} ] ) & ( 94 ) \\ {[ {y}_{a} ]}_{k} = {\sum }_{i = 1}^{2} {\vert {d}_{i} [ k ] a + {r}_{i} [ k ] \vert}^{2} & ( 95 )\end{matrix}$$

The false-alarm probability is given by:

$${P}_{FA} = P \{ ACK \vert DTX \} = \frac{1}{2} P \{ {max}_{a , \vert k \vert \leq K} \{ {\sum }_{i = 1}^{2} {\vert {d}_{i} [ k ] a + {r}_{i} [ k ] \vert}^{2} \} > λ \} = \frac{1}{2} ( 1 - P \{ {[ y ]}_{i} < λ ∀ i \} ) \qquad ( 96 )$$

It is to be understood that all probabilities in the above discussion are conditioned by DTX.

Thus, in order to calculate the false-alarm probability, the following term may be evaluated:

$$\begin{matrix} P \{ {[ y ]}_{i} < λ ∀ i \} = {( P \{ {[ y ]}_{2 i} < λ , {[ y ]}_{2 i + 1} < λ \} )}^{2 K + 1} & ( 97 ) \\ where \text{:} & \\ {V}_{i} = {d}_{i} [ k ] + {r}_{i} [ k ] & ( 98 ) \\ {W}_{i} = {d}_{i} [ k ] - {r}_{i} [ k ] & ( 99 ) \\ P \{ {[ y ]}_{2 i} < λ , {[ y ]}_{2 i + 1} < λ \} = P \{ {\vert {V}_{1} \vert}^{2} + {\vert {V}_{2} \vert}^{2} \leq λ , {\vert {W}_{1} \vert}^{2} + {\vert {W}_{2} \vert}^{2} \leq λ \} = {\int }_{{D}_{w}}^{ } {\int }_{{D}_{v}}^{ } {f}_{{\vert {V}_{1} \vert}^{2} , {\vert {V}_{2} \vert}^{2} , {\vert {W}_{1} \vert}^{2} , {\vert {W}_{2} \vert}^{2}} ( {v}_{1} , {v}_{2 } , {w}_{1} , {w}_{2} ) dvdw = {\int }_{0}^{λ} {\int }_{0}^{λ - {v}_{2}} {\int }_{0}^{λ} {\int }_{0}^{λ - {w}_{2}} {f}_{{\vert {V}_{1} \vert}^{2} , {\vert {W}_{1} \vert}^{2}} ( {v}_{1} , {w}_{1} ) {f}_{{\vert {V}_{2} \vert}^{2} , {\vert {W}_{2} \vert}^{2}} ( {v}_{2} , {w}_{2} ) d {w}_{1} d {w}_{2} d {v}_{1} d {v}_{2} & ( 100 ) \\ {F}_{{\vert {V}_{i} \vert}^{2} , {\vert {W}_{i} \vert}^{2}} ( v , w ) = P \{ {\vert {V}_{i} \vert}^{2} \leq v , {\vert {W}_{i} \vert}^{2} \leq w \} = {\int }_{{V}_{R}^{2} + {V}_{I}^{2} \leq v} {\int }_{{W}_{R}^{2} + {W}_{I}^{2} \leq w} {f}_{{V}_{R} , {W}_{R}} ( {v}_{r} , {w}_{r} ) {f}_{{V}_{I} , {W}_{I}} ( {v}_{i} , {w}_{i} ) d w d v & ( 101 )\end{matrix}$$

where f_{V}_{_{R}}_{,W}_{_{R}}(vᵣ,wᵣ) and f_{V}_{_{I}}_{,W}_{_{I}}(vᵢ,wᵢ) are the joint probability density functions (PDFs) of the real and imaginary parts of Vᵢ and Wᵢ.

From the definition of dᵢ[k] and rᵢ[k], f_{V}_{_{R}}_{,W}_{_{R}}(v,w)=f_{V}_{_{I}}_{,W}_{_{I}}(v,w)=f_{V,W}(v,w), where:

$$\begin{matrix}{f}_{V , W} ( v , w ) = \frac{1}{\sqrt{{( 2 π )}^{2} det ( {C}_{VW} )}} {e}^{- \frac{1}{2} [ \begin{matrix}v & w\end{matrix} ] {C}_{VW}^{- 1} [ \begin{matrix}v \\ w\end{matrix} ]} & ( 102 ) \\ {C}_{VW} = {\tilde{σ}}_{w}^{2} {N}_{d} \frac{1}{2} [ \begin{matrix}\frac{7}{12} & {r}_{VW} \\ {r}_{VW} & \frac{7}{12}\end{matrix} ] & ( 103 ) \\ {r}_{VW} = \frac{1}{12} & ( 104 )\end{matrix}$$

Converting to a polar coordinate system, yields:

$$\begin{matrix}{F}_{{\vert {V}_{i} \vert}^{2} , {\vert {W}_{i} \vert}^{2}} ( v , w ) = {\int }_{0}^{2 π} {\int }_{0}^{\sqrt{v}} {\int }_{0}^{2 π} {\int }_{0}^{\sqrt{w}} {f}_{V , W} ( {r}_{v} cos {θ}_{v} , {r}_{w} cos {θ}_{w} ) {f}_{V , W} ( {r}_{v} sin {θ}_{v} , {r}_{w} sin {θ}_{w} ) {r}_{v} {r}_{w} d {r}_{v} d {r}_{w} d {θ}_{v} d {θ}_{w} = - {\int }_{0}^{2 π} {\int }_{0}^{\sqrt{v}} {\int }_{0}^{2 π} {\int }_{0}^{\sqrt{w}} \frac{144 {r}_{v} {r}_{w} {e}^{\frac{12 ( 7 {r}_{v}^{2} - 24 {r}_{VW} cos ( {θ}_{v} - {θ}_{w} ) {r}_{v} {r}_{w} + 7 {r}_{w}^{2} )}{144 {r}_{VW} {\tilde{σ}}_{w}^{2} - 49 {\tilde{σ}}_{w}^{2}}}}{{\tilde{σ}}_{w}^{4} {π}^{2} ( 144 {r}_{VW}^{2} - 49 )} {r}_{v} {r}_{w} {dr}_{v} {dr}_{w} d {θ}_{v} d {θ}_{w} & ( 105 ) \\ Thus \text{:} & \\ {f}_{{\vert {V}_{i} \vert}^{2} , {\vert {W}_{i} \vert}^{2}} ( v , w ) = \frac{{\partial }^{2}}{\partial v \partial w} {F}_{{\vert {V}_{i} \vert}^{2} , {\vert {W}_{i} \vert}^{2}} ( v , w ) = \frac{72 {e}^{\frac{84 ( v + w )}{144 {r}_{VW}^{2} {\tilde{σ}}_{w}^{2} - 49 {\tilde{σ}}_{w}^{2}}} {\int }_{0}^{2 π} {e}^{\frac{288 \sqrt{vw} {r}_{VW} cos {θ}_{1}}{144 {r}_{VW}^{2} {\tilde{σ}}_{w}^{2} - 49 {\tilde{σ}}_{w}^{2}}} d {θ}_{1}}{49 {\tilde{σ}}_{w}^{4} π - 144 {r}_{VW}^{2} {\tilde{σ}}_{w}^{4} π} = \frac{72 {e}^{\frac{84 ( v + w )}{144 {r}_{VW}^{2} {\tilde{σ}}_{w}^{2} - 49 {σ}_{w}^{2}} 2 {I}_{0} ( \frac{288 \sqrt{vw} {r}_{VW}}{144 {r}_{VW}^{2} {\tilde{σ}}_{w}^{2} - 49 {\tilde{σ}}_{w}^{2}} )}}{49 {\tilde{σ}}_{w}^{4} - 144 {r}_{VW}^{2} {\tilde{σ}}_{w}^{4}} & ( 106 )\end{matrix}$$

Substituting Eq. 106 into Eq. 100 produces the following integral:

$$P \{ {[ y ]}_{2 i} < λ , {[ y ]}_{2 i + 1} < λ \} = {\int }_{0}^{λ} {\int }_{0}^{λ - {v}_{2}} {\int }_{0}^{λ} {\int }_{0}^{λ - {w}_{2}} \frac{72 {e}^{\frac{84 ( {v}_{1} + {w}_{1} )}{144 {r}_{VW}^{2} {\tilde{σ}}_{w}^{2} - 49 {\tilde{σ}}_{w}^{2}} 2 {I}_{0} ( \frac{288 \sqrt{{v}_{1} {w}_{1}} {r}_{VW}}{144 {r}_{VW}^{2} {\tilde{σ}}_{w}^{2} - 49 {\tilde{σ}}_{w}^{2}} )}}{49 {\tilde{σ}}_{w}^{4} - 144 {r}_{VW}^{2} {\tilde{σ}}_{w}^{4}} \frac{72 {e}^{\frac{84 ( {v}_{2} + {w}_{2} )}{144 {r}_{VW}^{2} {\tilde{σ}}_{w}^{2} - 49 {\tilde{σ}}_{w}^{2}} 2 {I}_{0} ( \frac{288 \sqrt{{v}_{2} {w}_{2}} {r}_{VW}}{144 {r}_{VW}^{2} {\tilde{σ}}_{w}^{2} - 49 {\tilde{σ}}_{w}^{2}} )}}{49 {\tilde{σ}}_{w}^{4} - 144 {r}_{VW}^{2} {\tilde{σ}}_{w}^{4}} {dw}_{1} {dw}_{2} {dv}_{1} {dv}_{2} \qquad ( 107 )$$

which may not be analytically solvable. Accordingly, the approximation r_{VW}≈0 may be introduced, which is justified by the fact that the correlation coefficient of V and W is rather small (ρ_{VW}= 1/7). With this approximation in hand, Eq. 107 reduces to the following:

$$\begin{matrix}\begin{matrix}P \{ {[ y ]}_{2 i} < λ , {[ y ]}_{2 i + 1} < λ \} \approx {\int }_{0}^{λ} {\int }_{0}^{λ - {v}_{2}} {\int }_{0}^{λ} {\int }_{0}^{λ - {w}_{2}} \frac{20736 {e}^{- \frac{12 {v}_{1}}{7 {\tilde{σ}}_{w}^{2}}} {e}^{- \frac{12 {v}_{2}}{7 {\tilde{σ}}_{w}^{2}}} {e}^{- \frac{12 {w}_{1}}{7 {\tilde{σ}}_{w}^{2}}} {e}^{- \frac{12 {w}_{2}}{7 {\tilde{σ}}_{w}^{2}}}}{2401 {\tilde{σ}}_{w}^{8}} \\ {dw}_{1} {dw}_{2} {dv}_{1} {dv}_{2} \\ = \frac{{e}^{- \frac{24 λ}{7 {\tilde{σ}}_{w}^{2}}}}{49 {\tilde{σ}}_{w}^{4}} {( 12 λ + 7 {\tilde{σ}}_{w}^{2} - 7 {\tilde{σ}}_{w}^{2} {e}^{\frac{12 λ}{7 {\tilde{σ}}_{w}^{2}}} )}^{2}\end{matrix} & ( 108 ) \\ {P}_{FA} = \frac{1}{2} ( 1 - {[ \frac{{e}^{- \frac{24 λ}{7 {\tilde{σ}}_{w}^{2}}}}{49 {\tilde{σ}}_{w}^{4}} {( 12 λ + 7 {\tilde{σ}}_{w}^{2} - 7 {\tilde{σ}}_{w}^{2} {e}^{\frac{12 λ}{7 {\tilde{σ}}_{w}^{2}}} )}^{2} ]}^{2 K + 1} ) & ( 109 )\end{matrix}$$

Because low P_{FA} values are of interest, it may be reasonable to assume

$$\frac{λ}{{\tilde{σ}}_{w}^{2}} >> 1.$$

Thus, we can make the following approximation:

$$\begin{matrix}{{e}^{- \frac{24 λ}{7 {\tilde{σ}}_{w}^{2}}} ( \begin{matrix}12 λ + 7 {\tilde{σ}}_{w}^{2} - \\ 7 {\tilde{σ}}_{w}^{2} {e}^{\frac{12 λ}{7 {\tilde{σ}}_{w}^{2}}}\end{matrix} )}^{2} = {( 12 λ {e}^{- \frac{12 λ}{7 {\tilde{σ}}_{w}^{2}}} + 7 {\tilde{σ}}_{w}^{2} ( {e}^{\frac{12 λ}{7 {\tilde{σ}}_{w}^{2}}} - 1 ) )}^{2} \\ \approx {( 12 λ {e}^{- \frac{12 λ}{7 {\tilde{σ}}_{w}^{2}}} + 7 {\tilde{σ}}_{w}^{2} )}^{2}\end{matrix} \qquad ( 110 )$$

Substituting the above result in Eq. 109 yields an analytical solution for λ, which is given by:

$$\begin{matrix}λ = - \frac{7 {\tilde{σ}}_{w}^{2}}{12} {W}_{- 1} ( {( 1 - 2 {P}_{FA} )}^{\frac{1}{2 ( 2 K + 1 )}} - 1 ) \\ = - \frac{7 R {σ}_{w}^{2}}{3} {W}_{- 1} ( {( 1 - 2 {P}_{FA} )}^{\frac{1}{2 ( 2 K + 1 )}} - 1 )\end{matrix} \qquad ( 111 )$$

where W₋₁(x) is the LambertW function.

If the receiver is configured for Doppler spread, the detector's decision rule becomes:

$${max}_{a , \vert k \vert \leq K} \{ Π [ k ] * ( {\sum }_{i = 1}^{2} {\vert {d}_{i} [ k ] a + {r}_{i} [ k ] \vert}^{2} ) \} > λ \qquad ( 112 )$$

with Π[k] defined in Eq. 87.

If:

$$\begin{matrix}\tilde{y} = vec ( [ \begin{matrix}{\tilde{y}}_{1}^{T} \\ {\tilde{y}}_{- 1}^{T}\end{matrix} ] ) & ( 113 ) \\ {[ {\tilde{y}}_{a} ]}_{k} = Π [ k ] * ( {\sum }_{i = 1}^{2} {\vert {d}_{i} [ k ] a + {r}_{i} [ k ] \vert}^{2} ) & ( 114 )\end{matrix}$$

then the DTX to ACK probability is given by:

P_{FA}=P{ACK|DTX}=½(1−P{[\tilde{y}]ᵢ<λ∀i}) (115)

As in the previous analysis, the dependence between [y₁]ₖ and [\tilde{y}₋₁]ₖ may be neglected (i.e., they may be treated as though independent). This approximation yields:

P{[\tilde{y}]ᵢ<λ∀i}≈(P{[\tilde{y}₁]ᵢ<λ∀i})² (116)

Due to the convolution with the square pulse, adjacent samples in \tilde{y}₁ are highly correlated, with the correlation span determined by the window length N_{W}. Since the exact distributions may in some cases be difficult to handle, the following approximation may be employed:

$$P \{ {[ {\tilde{y}}_{1} ]}_{i} < λ ∀ i \} \approx P {\{ {[ {\tilde{y}}_{1} ]}_{i} < λ \}}^{\frac{2 K + 1}{{ɛ}_{w} ( 2 {N}_{W} + 1 )}} \qquad ( 117 )$$

where 0<ε_{w}≤1 is an empiric constant (e.g., dependent on N_{w}) that denotes the fractional correlation length with respect to the full window length.

If processing were carried out without oversampling, the distribution of [\tilde{y}₁]ᵢ would simply be chi-squared with 4 (2N_{w}+1) degrees of freedom. However, due to the FFT oversampling by a factor of 2, this is no longer true for N_{W}>0. Since the utilized oversampling factor is 2, the number of independent RVs within the averaging window is assumed to be half of the window length, which leads to the following approximate PDF:

$$\begin{matrix}{f}_{[ {\tilde{y}}_{1} ]} ( y ) \approx \frac{{( \frac{y}{c} )}^{\frac{2 ( 2 {N}_{W} + 1 )}{c} - 1} {e}^{- \frac{y}{c ( \frac{7 {\tilde{σ}}_{w}^{2}}{12} )}}}{{c ( \frac{7 {\tilde{σ}}_{w}^{2}}{12} )}^{\frac{2 ( 2 {N}_{W} + 1 )}{c}} ( \frac{2 ( 2 {N}_{W} + 1 )}{c} - 1 ) !} & ( 118 ) \\ c = \{ \begin{matrix}1 & {N}_{W} = 0 \\ 2 & {N}_{W} > 0\end{matrix} & ( 119 )\end{matrix}$$

The cumulative distribution function (CDF) of [\tilde{y}₁]ᵢ is thus given by:

$$\begin{matrix}P \{ {[ {\tilde{y}}_{1} ]}_{i} < λ \} = {\int }_{0}^{λ} {f}_{{[ {\tilde{y}}_{1} ]}_{i}} ( y ) dy \\ = 1 - \frac{Γ ( \frac{2 ( 2 {N}_{W} + 1 )}{c} , \frac{12 λ}{7 c {\tilde{σ}}_{w}^{2}} )}{Γ ( \frac{2 ( 2 {N}_{W} + 1 )}{c} )} \\ = \frac{γ ( \frac{2 ( 2 {N}_{W} + 1 )}{c} , \frac{12 λ}{7 c {\tilde{σ}}_{w}^{2}} )}{Γ ( \frac{2 ( 2 {N}_{W} + 1 )}{c} )}\end{matrix} \qquad ( 120 )$$

where Γ(v,x) is the upper incomplete Gamma function, γ(v,x) is the lower incomplete Gamma function, and Γ(x) is the Gamma function. Accordingly (i.e., from Eq. 115-120)):

$${P}_{FA} \approx \frac{1}{2} ( 1 - {( \overline{γ} ( \frac{2 ( 2 {N}_{W} + 1 )}{c} , \frac{12 λ}{7 c {\tilde{σ}}_{w}^{2}} ) )}^{\frac{2 ( 2 K + 1 )}{{ɛ}_{w} ( 2 {N}_{W} + 1 )}} ) \qquad ( 121 )$$

where

$$\overline{γ} ( v , x ) = \frac{γ ( v , x )}{Γ ( v )}$$

is the regularized lower incomplete Gamma function.

Re-arranging Eq. 121 yields:

$$\overline{γ} ( \frac{2 ( 2 {N}_{W} + 1 )}{c} , \frac{12 λ}{7 c {\tilde{σ}}_{w}^{2}} ) = {( 1 - 2 {P}_{FA} )}^{\frac{2 ( 2 K + 1 )}{{ɛ}_{w} ( 2 {N}_{W} + 1 )}} \qquad ( 122 )$$

or, equivalently:

$$1 - {e}^{- \frac{12 λ}{7 {\tilde{σ}}_{w}^{2}}} {\sum }_{k = 0}^{\frac{2 ( 2 {N}_{W} + 1 )}{c} - 1} \frac{{( \frac{12 λ}{7 {\tilde{σ}}_{w}^{2}} )}^{k}}{k !} = {( 1 - 2 {P}_{FA} )}^{\frac{{ɛ}_{w} ( 2 {N}_{W} + 1 )}{2 ( 2 K + 1 )}} \qquad ( 123 )$$

By the same justification as above, it may be assumed that

$$\frac{λ}{{\tilde{σ}}_{w}^{2}} >> 1 ,$$

which enables the following approximation:

$${e}^{- \frac{12 λ}{7 c {\tilde{σ}}_{w}^{2}}} {\sum }_{k = 0}^{\frac{2 ( 2 {N}_{W} + 1 )}{c} - 1} \frac{{( \frac{12 λ}{7 c {\tilde{σ}}_{w}^{2}} )}^{k}}{k !} \approx {e}^{- \frac{12 λ}{7 c {\tilde{σ}}_{w}^{2}}} \frac{{( \frac{12 λ}{7 c {\tilde{σ}}_{w}^{2}} )}^{\frac{2 ( 2 {N}_{W} + 1 )}{c} - 1}}{( \frac{2 ( 2 {N}_{W} + 1 )}{c} - 1 ) !} \qquad ( 124 )$$

With this approximation, Eq. 123 may be rewritten as follows:

$$1 - {e}^{- \frac{12 λ}{7 c {\tilde{σ}}_{w}^{2}}} \frac{{( \frac{12 λ}{7 c {\tilde{σ}}_{w}^{2}} )}^{\frac{2 ( 2 {N}_{W} + 1 )}{c} - 1}}{( \frac{2 ( 2 {N}_{W} + 1 )}{c} - 1 ) !} \approx {( 1 - 2 {P}_{FA} )}^{\frac{{ɛ}_{w} ( 2 {N}_{W} + 1 )}{2 ( 2 K + 1 )}} \qquad ( 125 )$$

Solving for λ and simplifying yields:

$$λ = - \frac{7 R {σ}_{w}^{2} [ 2 ( 2 {N}_{W} + 1 ) - c ]}{3} {W}_{- 1} ( ( - \frac{c}{[ 2 ( 2 {N}_{W} + 1 ) - c ]} ) {( ( \frac{2 ( 2 {N}_{W} + 1 )}{c} - 1 ) ! ( 1 - {( 1 - 2 {P}_{FA} )}^{\frac{{ɛ}_{w} ( 2 {N}_{W} + 1 )}{2 ( 2 K + 1 )}} ) )}^{\frac{c}{2 ( 2 {N}_{W} + 1 ) - c}} ) \qquad ( 126 )$$

where the values of ε_{w} were determined empirically for the valid range of N_{W}, as listed in Table 2 below:

| N_{w} | ε_{w} |
|---|---|
| 0 | 1 |
| 1 | 0.87 |
| 2 | 0.5 |
| 3 | 0.4 |
| 4 | 0.3 |
| 5 | 0.28 |

By substituting N_{W}=0, c=1 into Eq. 126, it can be shown that the approximation coincides with Eq. 111 (e.g., which was derived without Doppler configuration).

It is to be noted from Eq. 111 that the threshold is proportional to the noise variance. In some cases, however, O_{w}² is unknown and must be estimated in order to properly calibrate the threshold. Referring to Eq. 28, the following noise estimator may be employed:

$${\hat{σ}}_{w}^{2} = \frac{1}{80 R} {\sum }_{i = 1}^{2} {\sum }_{l = 0}^{4 R - 1} ( {\sum }_{m = \{ 1 , 3 , 4 , 6 \}} {\vert {Y}_{m , l}^{( i )} - {Y}_{m - 1 , l}^{( i )} \vert}^{2} + {\vert {Y}_{5 , l}^{( i )} - {Y}_{1 , l}^{( i )} \vert}^{2} ) \qquad ( 127 )$$

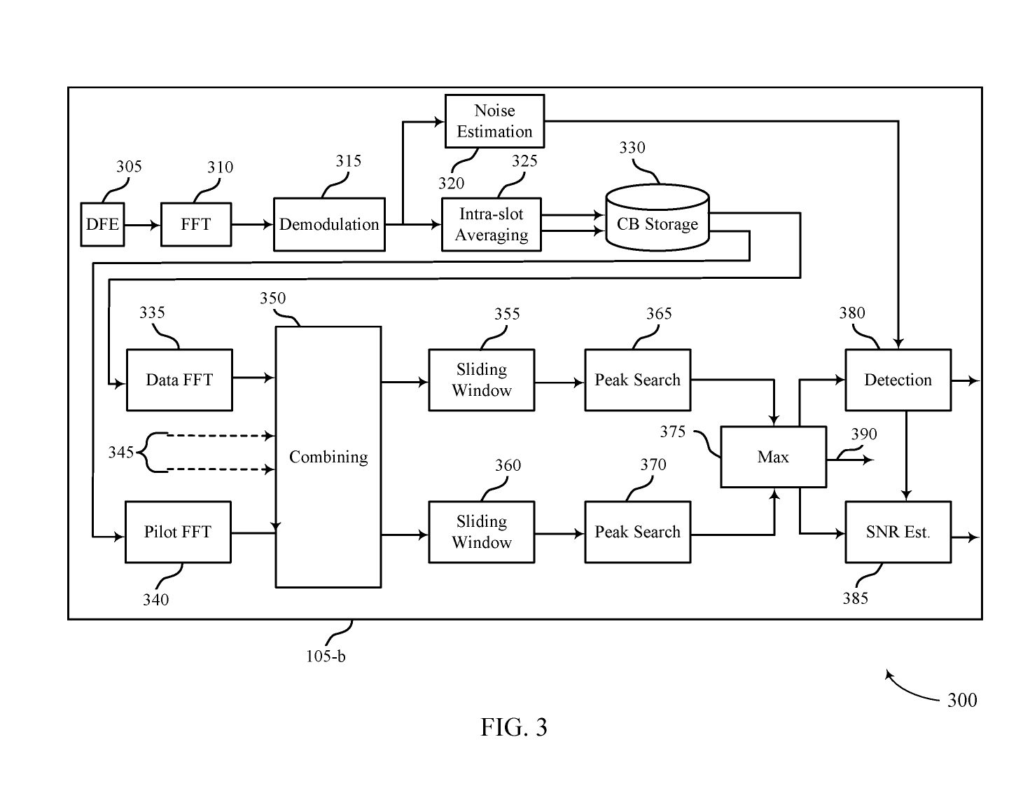

FIG. 3 illustrates an example of a narrowband receiver block diagram 300 that supports narrowband uplink control in accordance with aspects of the present disclosure. Narrowband receiver block diagram 400 may be an example of or a component of a base station 105-b, which may in turn be an example of the corresponding device described above. In some cases, narrowband receiver block diagram 400 may be an example of or a component of a UE 115 as described above (e.g., in a D2D communication scheme). In aspects of the following, a dotted arrow (e.g., as input to combining at 350) may indicate information 345 from a second antenna (e.g., which may improve the statistical validity of the results).

The following notations are employed in the equations that follow:
\tilde{l} is a symbol counter which ranges from \tilde{l}=0 in the first symbol of the first slot to \tilde{l}=28R−1 in the last symbol of the last slot.
(□)_{(m,n)} denotes quantization of the enclosed argument into a signed number having a total of m bits (including the sign bit), where the LSB is located at bit index n, counting from the first bit to the right of the radix point.
(□)_{(m,n)us} denotes quantization of the enclosed argument into an unsigned number having a total of m bits, where the LSB is located at bit index n, counting from the first bit to the right of the radix point.
rnd(□) denotes symmetric rounding, where mid-levels are alternately mapped to even and odd values.
sat(□) denotes (non-symmetric) saturation.
drp_msb(□) denotes dropping of the MSB.
<□>ₙ denotes the modulo-n operator.

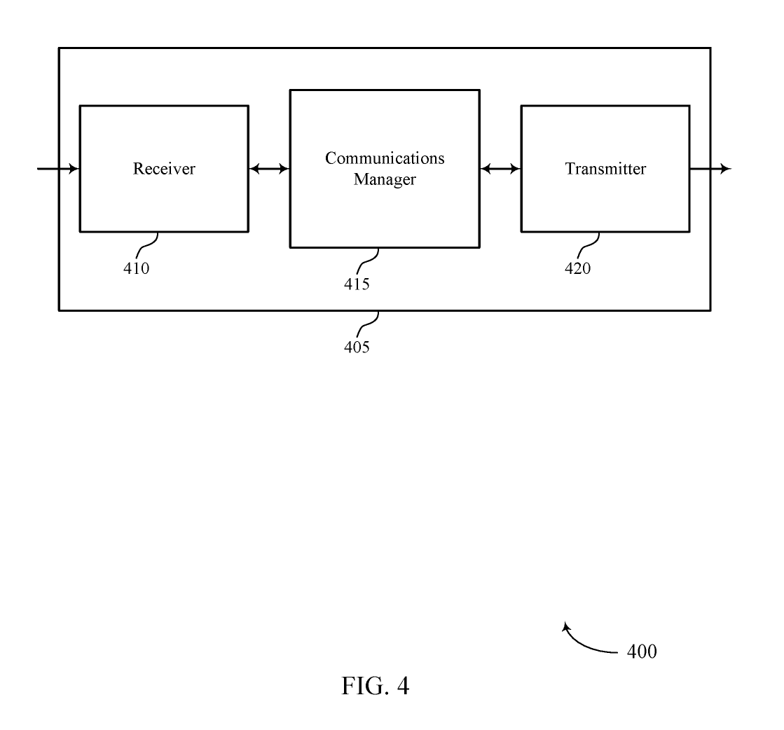

Various techniques described with reference to narrowband receiver block diagram 300 may be implemented by special purpose hardware, software executed by a processor, firmware, or any combination thereof. For instance, the techniques or operations as described with reference to narrowband receiver block diagram 300 may be implemented by various components of a wireless device, such as a base station 105 or a UE 115, as described herein. Examples of components that may be used include those described with reference to FIGS. 4 through 7. However, additional or different components may be used to perform the operations described herein without departing from the scope of the present disclosure.

At 305, digital front end (DFE) processing may be performed, including one or both of the following operations:
Down-sampling from the Primary Rate Interface (PRI) rate (e.g., 345.6/2=172.8 MHz) to the Fast Fourier Transform (FFT) input sampling rate Fₛ given by:

$${F}_{s} = \{ \begin{matrix}\frac{30.72}{( 20 / BW )} & in \text{-} band \\ 1.92 & stand \text{-} alone\end{matrix} [ MHz ] \qquad ( 128 )$$

Half SC shift removal (e.g., by setting the numerically controlled oscillator (NCO) frequency to

$${ω}_{0} = - 2 π \frac{1}{2} \frac{Δ f}{{F}_{s , NCO}} [ \frac{rad}{samp} ] ,$$

where F_{s,NCO} denotes the NCO sampling rate).

At 310, an FFT may be performed to transform the time-domain signal at the DFE output to the frequency domain. In some cases, the FFT may be performed using hardware, software, or a combination thereof. The operation of the FFT block may be approximated by the following mathematical expression:

$${\tilde{Y}}_{\tilde{l}}^{( i )} \approx {rnd ( {rnd ( {\sum }_{n = 0}^{\frac{{F}_{s}}{Δ f} - 1} {y}_{{〈 \tilde{l} 〉}_{7} , ⌊ \tilde{l} / 7 ⌋}^{( i )} [ n ] {e}^{- j 2 π \frac{Δ f}{{F}_{s}} {k}_{0} n} )}_{〈 22 , 15 〉} )}_{〈 16 , 15 - S 〉} \qquad ( 129 )$$

where S∈[0, . . . , 6] is the value of the FFT right-shifter at the output of the FFT module. In some cases, the value may be determined so as not to incur degradation in sensitivity while broadening the dynamic range of the incoming signal as much as possible.

In some cases, the automatic gain control (AGC) may settle on a maximal gain stage at all repetition levels. Since the lowest sensitivity point is approximately 13 dB, it follows that the signal power (including noise) at the analog to digital converter (ADC) input may be approximated as:

P_{ADC}≈−174+10 log₁₀(Δf)+NF+G[dBm] (130)

where NF stands for the noise-figure and G denotes the AGC gain.

Considering that the ADC full-scale is attained at 13.8 dBm, the power at the FFT input may be given by:

P_{FFT}_{_}_{IN}=P_{ADC}−13.8[dBFS] (131)

Thus, the subcarrier power may be given by:

$$\begin{matrix}{P}_{SC} = {P}_{FFT \_ IN} - 10 {log}_{10} ( {( \frac{Δ f}{{F}_{s}} )}^{2} ) \\ = - 174 + NF + G - 13.8 - 10 {log}_{10} ( \frac{Δ f}{{F}_{s}^{2}} )\end{matrix} \qquad ( 132 )$$

In order for quantization at the FFT output to be negligible, the signal (e.g., the thermal noise) to quantization noise ratio be greater than 15 dB, giving rise to the following equation:

1.77+6·16+P_{SC}−6S>15 (133)

Solving for S yields the requirement:

$$S < \frac{- 105 + NF + G - 10 {log}_{10} ( \frac{Δ f}{{F}_{s}^{2}} )}{6} \qquad ( 134 )$$

Substituting the typical values NF=3 dB, G=50 dB, F_{S}=1920 kHz yields:

S<5.36 (135)

Thus, in some cases (e.g., for stand-alone mode) S=5 may be the proper value. Since the right-hand side of Eq. 134 is increasing with increasing values of Fₛ, it follows that S=5 satisfies the requirement also for in-band mode (e.g., under the assumption of only PUSCH Format 2 transmission). In some cases, S=4 may be the proper value. For the sake of explanation, it is assumed that S=5, which leads to the following FFT block equation:

$${\tilde{Y}}_{\tilde{l}}^{( i )} = {rnd ( {rnd ( {\sum }_{n = 0}^{\frac{{F}_{s}}{Δ f} - 1} {y}_{{〈 \tilde{l} 〉}_{7} , ⌊ \tilde{l} / 7 ⌋}^{( i )} [ n ] {e}^{- j 2 π \frac{Δ f}{{F}_{s}} {k}_{0} n} )}_{〈 22 , 15 〉} )}_{〈 16 , 10 〉} \qquad ( 136 )$$

Right-shifting by 5, yields the FFT output:

Ŷ_{\tilde{l}}=(\tilde{Y}_{\tilde{l}}⁽ⁱ⁾>5) [symbol] _{16,15} [symbol] (137)

which may serve as input to demodulation performed at 315.

At 315, demodulation may be performed. The demodulation process may be formulated in the following manner:

$$\begin{matrix} {Y}_{\tilde{l}}^{( i )} = rnd \& {sat ( {( {\hat{Y}}_{\tilde{l}}^{( i )} )}_{〈 16 , 15 〉} \cdot {( {δ}_{\tilde{l}} )}_{〈 16 , 15 〉} )}_{〈 16 , 15 〉} & ( 138 ) \\ {δ}_{\tilde{l}} = \{ \begin{matrix}{rnd ( ( 1 - {2}^{- 15} ) ( {b}_{\tilde{l}} {e}^{- j {π ( {ϕ}_{\tilde{l}} )}_{〈 16 , 15 〉}} ) )}_{〈 16 , 15 〉} & {〈 l 〉}_{7} ∈ \{ 0 , 1 , 5 , 6 \} \\ {rnd ( ( 1 - {2}^{- 15} ) ( {r}_{\tilde{l}} {e}^{- j {π ( {ϕ}_{\tilde{l}} )}_{〈 16 , 15 〉}} ) )}_{〈 16 , 15 〉} & {〈 l 〉}_{7} ∈ \{ 2 , 3 , 4 \}\end{matrix} & ( 139 ) \\ {b}_{\tilde{l}} = \{ \begin{matrix}1 & c ( {\tilde{l}}_{d} ) = 0 \\ - 1 & c ( {\tilde{l}}_{d} ) = 1\end{matrix} & ( 140 ) \\ {r}_{\tilde{l}} = {r}_{u} ( {\tilde{l}}_{r} ) {e}^{- j \frac{π}{4}} & ( 141 ) \\ {ϕ}_{\tilde{l}} = drp\_msb {( {( 0.25 )}_{〈 8 , 8 〉} + {( 0.5 )}_{〈 8 , 8 〉} {〈 \tilde{l} 〉}_{2} + {( {ϕ}_{l} )}_{〈 16 , 15 〉} )}_{〈 16 , 15 〉} & ( 142 ) \\ {\tilde{ϕ}}_{\tilde{l}} = drp\_msb {( {( {\tilde{ϕ}}_{l - 1} )}_{〈 16 , 15 〉} + {( {〈 {c}_{\tilde{ϕ}} 〉}_{〈 16 , 15 〉} {( k )}_{〈 2 , 0 〉} )}_{〈 18 , 15 〉} )}_{〈 16 , 15 〉} & ( 143 ) \\ {c}_{ϕ} = \{ \begin{matrix}{( 0 \times 1200 )}_{〈 16 , 15 〉} & {〈 \tilde{l} 〉}_{7} \neq 0 \\ {( 0 \times 1400 )}_{〈 16 , 15 〉} & {〈 \tilde{l} 〉}_{7} = 0\end{matrix} & ( 144 ) \\ {\tilde{ϕ}}_{0} = 0 & ( 145 )\end{matrix}$$

where c(\tilde{l}_{d}) is a defined scrambling sequence in which the index \tilde{l}_{d} denotes the data-symbol index counting incrementally from the first data-symbol;

$${r}_{u} ( {\tilde{l}}_{r} ) = \pm \frac{1}{\sqrt{2}} ( 1 + j )$$

is a defined reference signal sequence in which the index \tilde{l}ᵣ denotes the reference-symbol index counting incrementally from the first reference-symbol; and k∈[0,3] is the PUSCH Format 2 subcarrier index. Based on the above definitions, it is to be noted that r_{\tilde{l}}∈{−1,1}. It is also to be noted that Eq. 143 incorporates the half sub-carrier shifting operation.

At 325, intra-slot averaging may be performed (e.g., to boost SNR of the received signal) according to the following input-output relation:

$$\begin{matrix}{\overline{d}}_{i} [ l ] = rnd \& {sat ( {( {( 3 )}_{〈 16 , 13 〉} \cdot {( {\sum }_{m ∈ \{ 0 , 1 , 5 , 6 \}} {( {Y}_{7 l + m}^{( i )} )}_{〈 16 , 15 〉} )}_{〈 18 , 15 〉} )}_{〈 34 , 28 〉} )}_{〈 16 , 14 〉} & ( 150 ) \\ \overline{{r}_{i}} [ l ] = {sat ( {( {\sum }_{m ∈ \{ 2 , 3 , 4 \}} {( {Y}_{7 l + m}^{( i )} )}_{〈 16 , 15 〉} << 2 )}_{〈 18 , 13 〉} )}_{〈 16 , 13 〉} & ( 151 )\end{matrix}$$

where d̅ᵢ is the vector of slot averaged data symbols and r̅ᵢ is the vector of slot averaged reference symbols.

At 320, noise estimation may be performed. The noise power estimate may be given by:

$${\hat{σ}}_{w}^{2} = rnd \&$$

$${sat ( {\sum }_{i = 1}^{2} {\sum }_{l = 0}^{4 R - 1} {sat ( {( {\sum }_{m = \{ 1 , 3 , 4 , 6 \}} \{ {( {( {Y}_{7 l + m}^{( l )} - {Y}_{7 l + m - 1}^{( l )} )}^{2} )}_{〈 34 , 30 〉} \} + \{ {( {( {Y}_{7 l + 3}^{( l )} - {Y}_{7 l + 1}^{( l )} )}^{2} )}_{〈 34 , 30 〉} \} + \{ {( {( {Y}_{7 l + 5}^{( l )} - {Y}_{7 l + 1}^{( l )} )}^{2} )}_{〈 34 , 30 〉} \} )}_{〈 16 , 30 〉} )}_{〈 16 + {log}_{2} ( 8 R ) , 30 〉} )}_{〈 40 , 30 〉}$$

At 330, code block (CB) storage may be performed. That is, the I/Q samples resulting from intra-slot averaging at 320 may be stored in the CB in preparation for the successive FFT operations, which are to be performed on the entire received set of data (i.e., the entire NPUSCH Format 2 transmission). Since there are two (2) complex samples per slot (i.e., one representing the data symbols and another representing the reference symbols) to be stored, 4R slots in total, and (in some examples) two (2) antennas, the total storage volume required for processing a single NPUSCH Format 2 channel may be approximately 8 kilobytes.

At 335, an FFT may be performed on the vector of slot-averaged data symbols:

$${d}_{i} [ k ] = fftshift ( rnd \& {sat ( {( {\sum }_{k = 0}^{4 R - 1} {\overline{d}}_{i} [ l ] {e}^{- j \frac{2 π}{8 R} kl} )}_{〈 16 + {n}_{b} , 14 〉} )}_{〈 16 , 13 〉} ) \qquad ( 153 )$$

Similarly, at 340 an FFT may be performed on the vector of slot-averaged reference symbols:

$${r}_{i} [ k ] = fftshift ( rnd \& {sat ( {( {\sum }_{l = 0}^{4 R - 1} \overline{{r}_{i}} [ l ] {e}^{- j \frac{2 π}{8 R} kl} )}_{〈 16 + {n}_{b} , 13 〉} )}_{〈 16 , 12 〉} ) \qquad ( 154 )$$

where −4R≤k<4R and (e.g., in the case that a hardware FFT is utilized at 310):

n_{b}=┌log₄(8R)┐ (155)

It is to be noted that the FFT operations at 335 and at 340 are equivalent to an 8R-point FFT with 4R-sample zero-padding.

At 350, a combining operation may be performed:

$${h}_{a} [ k ] = rnd \& {sat ( {( {\sum }_{i = 1}^{2} {( {( {( {d}_{i} [ k ] a + {r}_{i} [ k ] )}_{〈 18 , 13 〉} )}^{2} )}_{〈 36 , 26 〉} + {( {( {( {d}_{i} [ k ] a + {r}_{i} [ k ] )}_{〈 18 , 13 〉} )}^{2} )}_{〈 36 , 26 〉} )}_{〈 38 , 26 〉} )}_{〈 16 , 21 〉} \qquad ( 156 )$$

where a∈[−1,1] corresponds to a decoding hypothesis (e.g., an ACK or NACK). As described above, in some cases information from a second set of antennas 345 may be included in the combining at 350 (e.g., in order to improve the statistical validity of the results).

At 355 and 360, a sliding window operation may be performed on each hypothesis (i.e., a=−1 and a=1) independently. For example, each sliding window operation can be formulated in the following manner:

$${\tilde{h}}_{a} [ k ] = {sat ( {( {\sum }_{n = - {N}_{W}}^{{N}_{W}} {h}_{a} [ k + n ] )}_{〈 16 + ⌈ {log}_{2} ( 2 {N}_{W} + 1 ) ⌉ , 21 〉} )}_{〈 40 , 21 〉} , \\ - K \leq k \leq K \qquad ( 157 )$$

where 0≤N_{W}≤5 (i.e., the one-sided window size) and the maximal bin index K are given by:

N_{W}=rnd(f_{d}4R·10⁻³) (158)

K=┌fₘₐₓ4R·10⁻³┐ (159)

respectively. In these equations, 0≤f_{d}≤10 is the Doppler frequency and 0≤fₘₐₓ≤380 is the maximal frequency offset (in Hz), e.g., which may be examples of configurable parameters. For example, the parameter f_{d} may be derived from the user-defined parameter TypicalDopplerFreq such that:

$${f}_{d} = \{ \begin{matrix}0 & R < 64 \\ TypicalDopplerFreq & R \geq 64\end{matrix} \qquad ( 160 )$$

where the following default values may be employed:

TypicalDopplerFreq (default)=5 (161)

fₘₐₓ(default)=250 (162)

Alternatively, Eq. (5.26) may equivalently be written in recursive form:

$$\begin{matrix}{\tilde{h}}_{a} [ k ] = {sat ( {( {\tilde{h}}_{a} [ k - 1 ] )}_{〈 40 , 21 〉} + {( {h}_{a} [ k + {N}_{W} ] - {h}_{a} [ k - 1 - {N}_{W} ] )}_{〈 17 , 21 〉} )}_{〈 40 , 21 〉} , \\ - K \leq k \leq K & ( 163 ) \\ {\tilde{h}}_{a} [ - K - 1 ] = {( {\sum }_{n = - K - 1 - {N}_{W}}^{- K - 1 + {N}_{W}} {h}_{a} [ n ] )}_{〈 40 , 21 〉} & ( 164 )\end{matrix}$$

At 365 and 370, a peak search operation may be performed on each hypothesis (i.e., a=−1 and a=1) independently. For example, each peak search operation may be given by:

$${\tilde{h}}_{a , max} = {max}_{- K \leq k \leq K} \{ {\tilde{h}}_{a} [ k ] \} \qquad ( 165 )$$

where K is defined in Eq. 159.

At 375, a maximum operation may be performed. As illustrated, the maximum operation has two outputs, given by:

$$\begin{matrix}{\tilde{h}}_{max} = max \{ {\tilde{h}}_{1 , max} , {\tilde{h}}_{- 1 , max} \} & ( 166 ) \\ \hat{a} = {arg max}_{a} \{ {\tilde{h}}_{a , max} \} & ( 167 )\end{matrix}$$

where â is the decoded symbol that is output at 390 with the following mapping:

$$decoder\_out = \{ \begin{matrix}ACK & \hat{a} = 1 \\ NACK & \hat{a} = - 1\end{matrix} \qquad ( 168 )$$

In aspects, \tilde{h}ₘₐₓ may be fed to a detection operation at 380. The operations at 380 may be given by the following equations:

$$\begin{matrix}{e}_{1} = clb ( {\hat{σ}}_{w}^{2} ) & ( 169 ) \\ {e}_{2} = clb ( {\tilde{h}}_{max} ) & ( 170 ) \\ {e}_{min} = min \{ {e}_{1} , {e}_{2} \} & ( 171 ) \\ {h}_{max} = drp\_msb {( {( extract ( {\tilde{h}}_{max} , {e}_{min} ) )}_{〈 16 , 15 〉} )}_{〈 15 , 15 〉 us} & ( 172 ) \\ μ = drp\_msb {( {( extract ( {\hat{σ}}_{w}^{2} , {e}_{min} ) )}_{〈 16 , 15 〉} )}_{〈 15 , 15 〉 us} & ( 173 ) \\ detector\_out = \{ \begin{matrix}DTX & {h}_{max} < λ \\ signal\_detected & {h}_{max} \geq λ\end{matrix} & ( 174 )\end{matrix}$$

where the detection threshold λ is given by:

$$λ = \{ \begin{matrix}rnd \& {sat ( {( μ )}_{〈 15 , 15 〉 us} \cdot rnd \& {sat ( - \frac{21}{5} {W}_{- 1} ( θ ) )}_{〈 16 , 9 〉 us} )}_{〈 15 , 15 〉 us} & {N}_{W} = 0 \\ {sat ( {( {N}_{W} )}_{〈 3 , 0 〉 us} rnd \& {sat ( 4 {( μ )}_{〈 15 , 15 〉 us} \cdot rnd \& {sat ( - \frac{21}{5} {W}_{- 1} ( θ ) )}_{〈 16 , 9 〉 us} )}_{〈 15 , 15 〉 us} )}_{〈 15 , 15 〉 us} & {N}_{W} > 0\end{matrix} \qquad ( 175 )$$

and where:

$$θ = \{ \begin{matrix}- rnd \& {sat ( 1 - {( 1 - 2 {P}_{FA} )}^{\frac{1}{2 ( 2 K + 1 )}} )}_{〈 20 , 20 〉 us} & {N}_{W} = 0 \\ - rnd \& {sat ( ( \frac{1}{2 {N}_{W}} ) {( ( 2 {N}_{W} ) ! ( 1 - {( 1 - 2 {P}_{FA} )}^{\frac{{ɛ}_{w} ( 2 {N}_{W} + 1 )}{2 ( 2 K + 1 )}} ) )}^{\frac{1}{2 {N}_{W}}} )}_{〈 20 , 20 〉 us} & {N}_{W} > 0\end{matrix} \qquad ( 176 )$$

K is defined in Eq. 159; \hat{σ}_{w}² was defined in Eq. 152; 10⁻⁴≤P_{FA}≤10⁻¹ is the desired false-alarm rate; and ε_{w} is determined based on the value of N_{W} according to Table 2. In some cases, the scaled LambertW function −21/5W₋₁(x) may be implemented as a fixed lookup table (LUT) of size 2.1 Mega-bytes. The input argument into the LUT (θ) may in some cases be computed by a processor (e.g., as it may depend on semi-static configuration parameters).

At 385, the post-processing SNR may be estimated in the following manner:

$$SNR = {sat ( {( 10 {log}_{10} ( {( {h}_{max} )}_{〈 15 , 15 〉 us} ) )}_{〈 16 , 9 〉} - {( 10 {log}_{10} ( {( μ )}_{〈 15 , 15 〉 us} ) )}_{〈 16 , 9 〉} + {( - 9.2 )}_{〈 16 , 9 〉} )}_{〈 16 , 9 〉} \qquad ( 177 )$$

where the normalization factor

$$- 10 {log}_{10} ( \frac{( {3}^{2} \cdot 4 + {4}^{2} \cdot 3 ) 4 R \cdot 2}{80 R} ) \approx - 9.2$$

is introduced to compensate for the intra-slot averaging, FFT, and noise estimation normalization factors.

FIG. 4 shows a block diagram 400 of a wireless device 405 that supports narrowband uplink control for wireless communications in accordance with aspects of the present disclosure. Wireless device 405 may be an example of aspects of a base station 105 as described herein. Wireless device 405 may include receiver 410, communications manager 415, and transmitter 420. Wireless device 405 may also include a processor. Each of these components may be in communication with one another (e.g., via one or more buses).

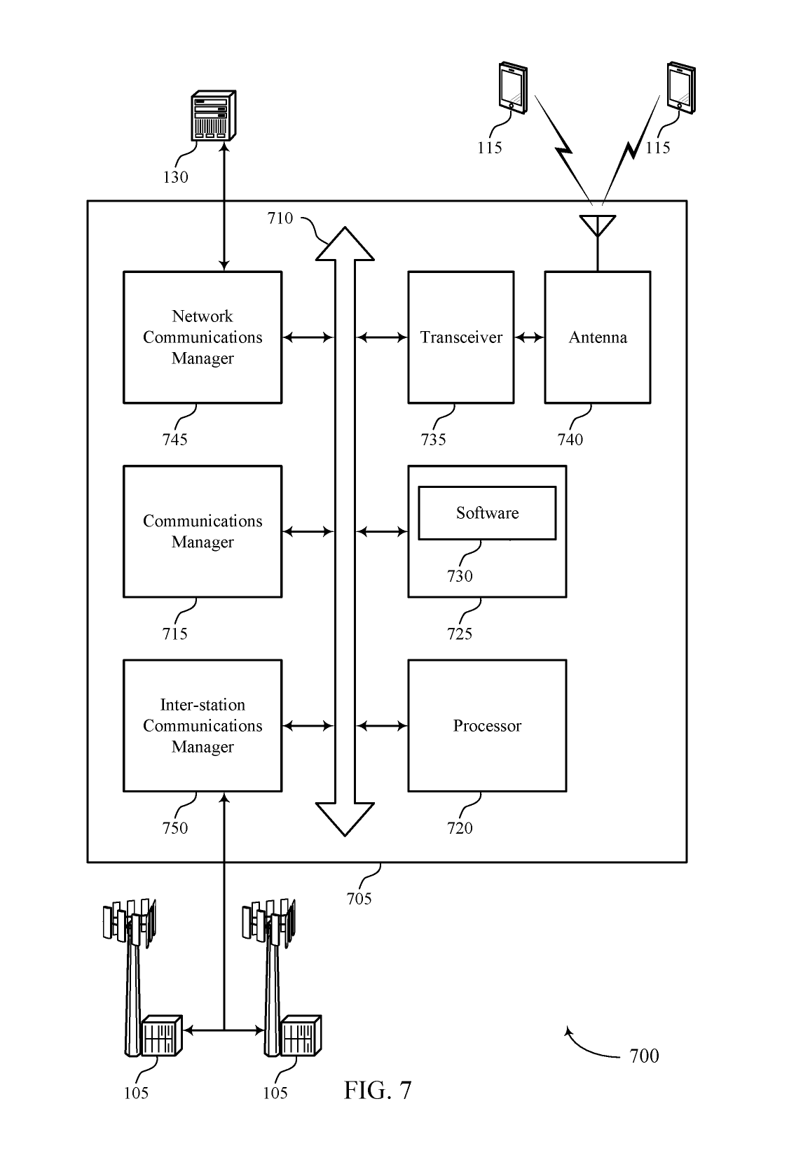

Receiver 410 may receive information such as packets, user data, or control information associated with various information channels (e.g., control channels, data channels, and information related to narrowband uplink control for wireless communications, etc.). Information may be passed on to other components of the device. The receiver 410 may be an example of aspects of the transceiver 735 described with reference to FIG. 7. The receiver 410 may utilize a single antenna or a set of antennas.

Communications manager 415 may be an example of aspects of the communications manager 715 described with reference to FIG. 7. Communications manager 415 and/or at least some of its various sub-components may be implemented in hardware, software executed by a processor, firmware, or any combination thereof. If implemented in software executed by a processor, the functions of the communications manager 415 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The communications manager 415 and/or at least some of its various sub-components may be physically located at various positions, including being distributed such that portions of functions are implemented at different physical locations by one or more physical devices. In some examples, communications manager 415 and/or at least some of its various sub-components may be a separate and distinct component in accordance with various aspects of the present disclosure. In other examples, communications manager 415 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Communications manager 415 may receive, from a UE, UCI including a set of RUs that each include at least one slot containing a set of data symbols and a set of reference symbols. Communications manager 415 may calculate, for each slot of each RU of the set of RUs, a data symbol estimate based on the set of data symbols of the slot and a reference symbol estimate based on the set of reference symbols of the slot. Communications manager 415 and decode at least a portion of the UCI based on the data symbol estimates and the reference symbol estimates.

Transmitter 420 may transmit signals generated by other components of the device. In some examples, the transmitter 420 may be collocated with a receiver 410 in a transceiver module. For example, the transmitter 420 may be an example of aspects of the transceiver 735 described with reference to FIG. 7. The transmitter 420 may utilize a single antenna or a set of antennas.

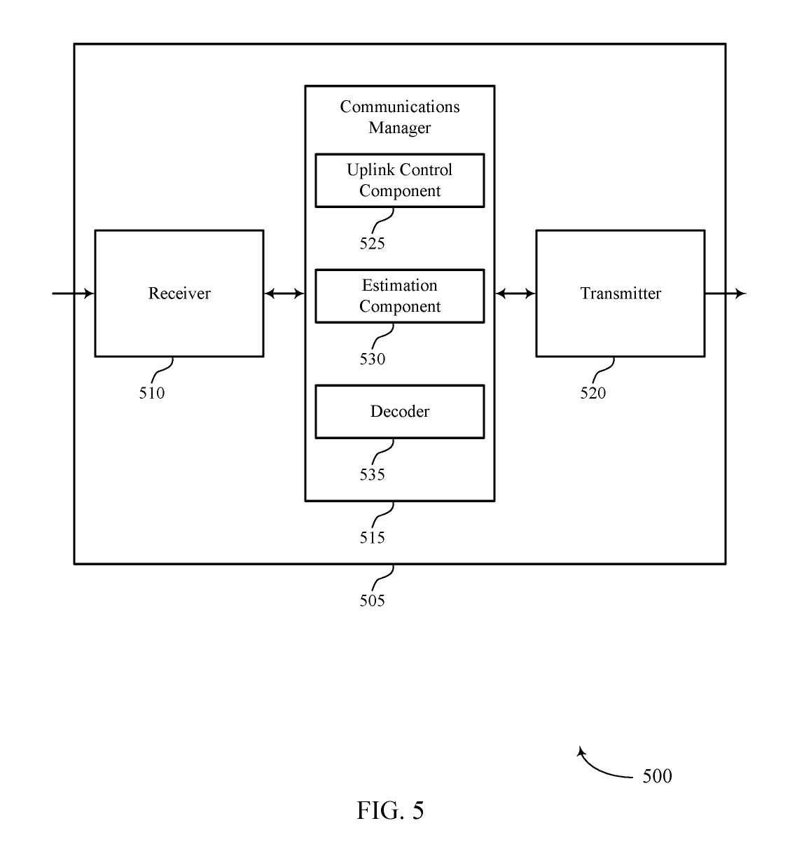

FIG. 5 shows a block diagram 500 of a wireless device 505 that supports narrowband uplink control for wireless communications in accordance with aspects of the present disclosure. Wireless device 505 may be an example of aspects of a wireless device 405 or a base station 105 as described with reference to FIG. 4. Wireless device 505 may include receiver 510, communications manager 515, and transmitter 520. Wireless device 505 may also include a processor. Each of these components may be in communication with one another (e.g., via one or more buses).

Receiver 510 may receive information such as packets, user data, or control information associated with various information channels (e.g., control channels, data channels, and information related to narrowband uplink control for wireless communications, etc.). Information may be passed on to other components of the device. The receiver 510 may be an example of aspects of the transceiver 735 described with reference to FIG. 7. The receiver 510 may utilize a single antenna or a set of antennas.

Communications manager 515 may be an example of aspects of the communications manager 715 described with reference to FIG. 7. Communications manager 515 may also include uplink control component 525, estimation component 530, and decoder 535.

Uplink control component 525 may receive, from a UE, UCI including a set of RUs that each include at least one slot containing a set of data symbols and a set of reference symbols. In some cases, the UCI is received in a narrowband transmission within a radio frequency spectrum band. In some cases, the UCI is received over multiple antennas.

Estimation component 530 may calculate, for each slot of each RU of the set of RUs, a data symbol estimate based on the set of data symbols of the slot and a reference symbol estimate based on the set of reference symbols of the slot. For example, estimation component 530 may calculate a first noise cancellation average for the slot and calculate a second noise cancellation average for the slot. Decoder 535 may decode at least a portion of the UCI based on the data symbol estimates and the reference symbol estimates.

Transmitter 520 may transmit signals generated by other components of the device. In some examples, the transmitter 520 may be collocated with a receiver 510 in a transceiver module. For example, the transmitter 520 may be an example of aspects of the transceiver 735 described with reference to FIG. 7. The transmitter 520 may utilize a single antenna or a set of antennas.

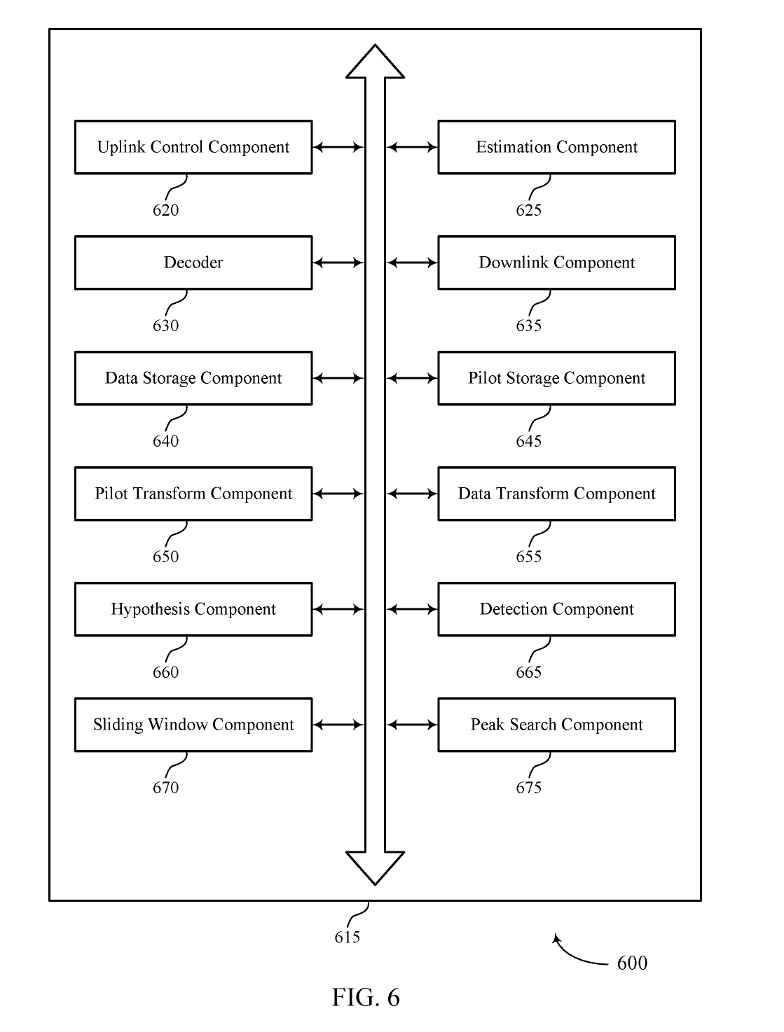

FIG. 6 shows a block diagram 600 of a communications manager 615 that supports narrowband uplink control for wireless communications in accordance with aspects of the present disclosure. The communications manager 615 may be an example of aspects of a communications manager 415, a communications manager 515, or a communications manager 715 described with reference to FIGS. 4, 5, and 7. The communications manager 615 may include uplink control component 620, estimation component 625, decoder 630, downlink component 635, data storage component 640, pilot storage component 645, pilot transform component 650, data transform component 655, hypothesis component 660, likelihood component 665, sliding window component 670, peak search component 675, and detection component 680. Each of these modules may communicate, directly or indirectly, with one another (e.g., via one or more buses).

Uplink control component 620 may receive, from a UE, UCI including a set of RUs that each include at least one slot containing a set of data symbols and a set of reference symbols. In some cases, the UCI is received in a narrowband transmission within a radio frequency spectrum band. In some cases, the UCI is received over multiple antennas.

Estimation component 625 may calculate, for each slot of each RU of the set of RUs, a data symbol estimate based on the set of data symbols of the slot and a reference symbol estimate based on the set of reference symbols of the slot (e.g., as described above with reference to 325). Estimation component 625 may in some cases calculate a first noise cancellation average for the slot and calculate t a second noise cancellation average for the slot.

Decoder 630 may decode at least a portion of the UCI based on the data symbol estimates and the reference symbol estimates.

Downlink component 635 may transmit, to the UE, a message in a narrowband transmission within a radio frequency spectrum band, where the UCI is received in response to the message.

Data storage component 640 may store each data symbol estimate in a data buffer (e.g., as described above with reference to 330).

Pilot storage component 645 may store each reference symbol estimate in a pilot buffer, where decoding the symbol is based on the stored data buffer and the stored pilot buffer (e.g., as described above with reference to 330).

Pilot transform component 650 may perform a first Fourier transform on the stored pilot buffer to obtain a frequency-domain pilot sequence (e.g., as described above with reference to 340).

Data transform component 655 may perform a second Fourier transform on the stored data buffer to obtain a frequency-domain data sequence, where decoding at least the portion of the UCI is based on the frequency-domain pilot sequence and the frequency-domain data sequence (e.g., as described above with reference to 335).

Hypothesis component 660 may compute a first hypothesis function and a second hypothesis function based on the frequency-domain pilot sequence and the frequency-domain data sequence (e.g., as described above with reference to 350).

Detection component 665 may perform a detection operation based on the first and second hypothesis functions, where decoding at least the portion of the UCI is based on the detection operation. In some cases, the detection operation includes a sliding window operation and a peak search operation. In some cases, the detection operation is based on an expected CFO corresponding to a channel over which the UCI is received.

Sliding window component 670 may convolve the pulse with the first hypothesis function to obtain a first windowed function (e.g., as described above with reference to 355). In some cases, the sliding window operation includes convolving a pulse with the second hypothesis function to obtain a second windowed function (e.g., as described above with reference to 360). In some cases, a width of the pulse is determined based on a Doppler spread of a channel over which the UCI is received.

Peak search component 675 may determine a first maximum value of the first windowed function (e.g., as described above with reference to 365) and determine a second maximum value of the second windowed function (e.g., as described above with reference to 370). In some cases, peak search component 675 may select a greater of the first maximum value and the second maximum value. Decoding at least the portion of the UCI may be based on the selection. For example, detection component 665 may in some cases compare at least one of the first maximum value or the second maximum value to a threshold, classify the UCI as a valid transmission based on the comparison, and select the threshold based on a false-alarm/missed-detection (FA/MD) rate (e.g., as described above with reference to 380).

FIG. 7 shows a diagram of a system 700 including a device 705 that supports narrowband uplink control for wireless communications in accordance with aspects of the present disclosure. Device 705 may be an example of or include the components of wireless device 405, wireless device 505, or a base station 105 as described above, e.g., with reference to FIGS. 4 and 5. Device 705 may include components for bi-directional voice and data communications including components for transmitting and receiving communications, including communications manager 715, processor 720, memory 725, software 730, transceiver 735, antenna 740, network communications manager 745, and inter-station communications manager 750. These components may be in electronic communication via one or more buses (e.g., bus 710). Device 705 may communicate wirelessly with one or more UEs 115.

Processor 720 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 720 may be configured to operate a memory array using a memory controller. In other cases, a memory controller may be integrated into processor 720. Processor 720 may be configured to execute computer-readable instructions stored in a memory to perform various functions (e.g., functions or tasks supporting narrowband uplink control for wireless communications).

Memory 725 may include random access memory (RAM) and read only memory (ROM). The memory 725 may store computer-readable, computer-executable software 730 including instructions that, when executed, cause the processor to perform various functions described herein. In some cases, the memory 725 may contain, among other things, a basic input/output system (BIOS) which may control basic hardware or software operation such as the interaction with peripheral components or devices.

Software 730 may include code to implement aspects of the present disclosure, including code to support narrowband uplink control for wireless communications. Software 730 may be stored in a non-transitory computer-readable medium such as system memory or other memory. In some cases, the software 730 may not be directly executable by the processor but may cause a computer (e.g., when compiled and executed) to perform functions described herein.

Transceiver 735 may communicate bi-directionally, via one or more antennas, wired, or wireless links as described above. For example, the transceiver 735 may represent a wireless transceiver and may communicate bi-directionally with another wireless transceiver. The transceiver 735 may also include a modem to modulate the packets and provide the modulated packets to the antennas for transmission, and to demodulate packets received from the antennas.

In some cases, the wireless device may include a single antenna 740. However, in some cases the device may have more than one antenna 740, which may be capable of concurrently transmitting or receiving multiple wireless transmissions.

Network communications manager 745 may manage communications with the core network (e.g., via one or more wired backhaul links). For example, the network communications manager 745 may manage the transfer of data communications for client devices, such as one or more UEs 115.

Inter-station communications manager 750 may manage communications with other base station 105, and may include a controller or scheduler for controlling communications with UEs 115 in cooperation with other base stations 105. For example, the inter-station communications manager 750 may coordinate scheduling for transmissions to UEs 115 for various interference mitigation techniques such as beamforming or joint transmission. In some examples, inter-station communications manager 750 may provide an X2 interface within an LTE/LTE-A wireless communication network technology to provide communication between base stations 105.

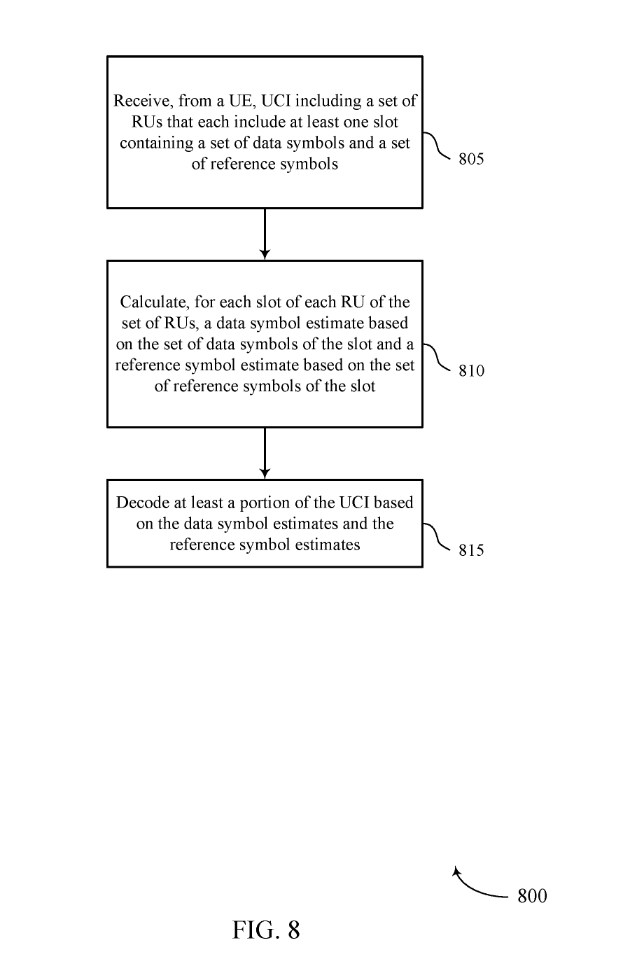

FIG. 8 shows a flowchart illustrating a method 800 for narrowband uplink control for wireless communications in accordance with aspects of the present disclosure. The operations of method 800 may be implemented by a base station 105 or its components as described herein. For example, the operations of method 800 may be performed by a communications manager as described with reference to FIGS. 4 through 7. In some examples, a base station 105 may execute a set of codes to control the functional elements of the device to perform the functions described below. Additionally or alternatively, the base station 105 may perform aspects of the functions described below using special-purpose hardware.

At block 805 the base station 105 may receive, from a UE, UCI including a plurality of RUs that each include at least one slot containing a set of data symbols and a set of reference symbols. The operations of block 805 may be performed according to the methods described herein. In certain examples, aspects of the operations of block 805 may be performed by a uplink control component as described with reference to FIGS. 4 through 7.

At block 810 the base station 105 may calculate, for each slot of each RU of the plurality of RUs, a data symbol estimate based at least in part on the set of data symbols of the slot and a reference symbol estimate based at least in part on the set of reference symbols of the slot. The operations of block 810 may be performed according to the methods described herein. In certain examples, aspects of the operations of block 810 may be performed by a estimation component as described with reference to FIGS. 4 through 7.

At block 815 the base station 105 may decode at least a portion of the UCI based at least in part on the data symbol estimates and the reference symbol estimates. The operations of block 815 may be performed according to the methods described herein. In certain examples, aspects of the operations of block 815 may be performed by a decoder as described with reference to FIGS. 4 through 7.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of eNBs provide coverage for various geographical regions. For example, each eNB, next generation NodeB (gNB), or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), gNB, Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a base station, comprising:
receiving, from a user equipment (UE), uplink control information (UCI) including a plurality of resource units (RUs) that each include at least one slot containing a set of data symbols and a set of reference symbols;
calculating, for each slot of each RU of the plurality of RUs, a data symbol estimate based at least in part on the set of data symbols of the slot and a reference symbol estimate based at least in part on the set of reference symbols of the slot; and
decoding at least a portion of the UCI based at least in part on the data symbol estimates and the reference symbol estimates.

2. The method of claim 1, further comprising:
transmitting, to the UE, a message in a narrowband transmission within a radio frequency spectrum band, wherein the UCI is received in response to the message.

3. The method of claim 1, wherein:
calculating the data symbol estimate for each slot comprises calculating a first noise cancellation average for the slot; and
calculating the reference symbol estimate for each slot comprises calculating a second noise cancellation average for the slot.

4. The method of claim 1, wherein the UCI is received in a narrowband transmission within a radio frequency spectrum band.

5. The method of claim 1, further comprising:
storing each data symbol estimate in a data buffer; and
storing each reference symbol estimate in a pilot buffer, wherein decoding the symbol is based at least in part on the stored data buffer and the stored pilot buffer.

6. The method of claim 5, further comprising:
performing a first Fourier transform on the stored pilot buffer to obtain a frequency-domain pilot sequence; and
performing a second Fourier transform on the stored data buffer to obtain a frequency-domain data sequence, wherein decoding at least the portion of the UCI is based at least in part on the frequency-domain pilot sequence and the frequency-domain data sequence.

7. The method of claim 6, further comprising:
computing a first hypothesis function and a second hypothesis function based at least in part on the frequency-domain pilot sequence and the frequency-domain data sequence.

8. The method of claim 7, further comprising:
performing a detection operation based at least in part on the first and second hypothesis functions, wherein decoding at least the portion of the UCI is based at least in part on the detection operation.

9. The method of claim 8, wherein the detection operation comprises a sliding window operation and a peak search operation.

10. The method of claim 9, wherein the sliding window operation comprises:
convolving a pulse with the first hypothesis function to obtain a first windowed function; and
convolving the pulse with the second hypothesis function to obtain a second windowed function.

11. The method of claim 10, wherein a width of the pulse is determined based at least in part on a Doppler spread of a channel over which the UCI is received.

12. The method of claim 10, wherein the peak search operation comprises:
determining a first maximum value of the first windowed function;
determining a second maximum value of the second windowed function; and
selecting a greater of the first maximum value and the second maximum value, wherein decoding at least the portion of the UCI is based at least in part on the selection.

13. The method of claim 12, further comprising:
comparing at least one of the first maximum value or the second maximum value to a threshold; and
classifying the UCI as a valid transmission based at least in part on the comparison.

14. The method of claim 13, further comprising:
selecting the threshold based at least in part on a false-alarm/missed-detection (FA/MD) rate.

15. The method of claim 8, wherein the likelihood operation is based at least in part on an expected carrier frequency offset (CFO) corresponding to a channel over which the UCI is received.

16. The method of claim 1, wherein the UCI is received over multiple antennas.

17. An apparatus for wireless communication at a base station, comprising:
means for receiving, from a user equipment (UE), uplink control information (UCI) including a plurality of resource units (RUs) that each include at least one slot containing a set of data symbols and a set of reference symbols;
means for calculating, for each slot of each RU of the plurality of RUs, a data symbol estimate based at least in part on the set of data symbols of the slot and a reference symbol estimate based at least in part on the set of reference symbols of the slot; and
means for decoding at least a portion of the UCI based at least in part on the data symbol estimates and the reference symbol estimates.

18. The apparatus of claim 17, further comprising:
means for computing a first hypothesis function and a second hypothesis function based at least in part on a frequency-domain pilot sequence and a frequency-domain data sequence.

19. An apparatus for wireless communication at a base station, comprising:
a processor;
memory in electronic communication with the processor; and
instructions stored in the memory and operable, when executed by the processor, to cause the apparatus to:
receive, from a user equipment (UE), uplink control information (UCI) including a plurality of resource units (RUs) that each include at least one slot containing a set of data symbols and a set of reference symbols;
calculate, for each slot of each RU of the plurality of RUs, a data symbol estimate based at least in part on the set of data symbols of the slot and a reference symbol estimate based at least in part on the set of reference symbols of the slot; and
decode at least a portion of the UCI based at least in part on the data symbol estimates and the reference symbol estimates.

20. The apparatus of claim 19, wherein the instructions are further executable by the processor to:
transmit, to the UE, a message in a narrowband transmission within a radio frequency spectrum band, wherein the UCI is received in response to the message.

21. The apparatus of claim 19, wherein the instructions are further executable by the processor to:
store each data symbol estimate in a data buffer; and
store each reference symbol estimate in a pilot buffer, wherein decoding the symbol is based at least in part on the stored data buffer and the stored pilot buffer.

22. The apparatus of claim 21, wherein the instructions are further executable by the processor to:
perform a first Fourier transform on the stored pilot buffer to obtain a frequency-domain pilot sequence; and
perform a second Fourier transform on the stored data buffer to obtain a frequency-domain data sequence, wherein decoding at least the portion of the UCI is based at least in part on the frequency-domain pilot sequence and the frequency-domain data sequence.

23. The apparatus of claim 22, wherein the instructions are further executable by the processor to:
compute a first hypothesis function and a second hypothesis function based at least in part on the frequency-domain pilot sequence and the frequency-domain data sequence.

24. The apparatus of claim 23, wherein the instructions are further executable by the processor to:
perform a detection operation based at least in part on the first and second hypothesis functions, wherein decoding at least the portion of the UCI is based at least in part on the detection operation.

25. The apparatus of claim 24, wherein the detection operation comprises a sliding window operation and a peak search operation.

26. The apparatus of claim 25, wherein the instructions are further executable by the processor to:
convolve a pulse with the first hypothesis function to obtain a first windowed function; and
convolve the pulse with the second hypothesis function to obtain a second windowed function.

27. The apparatus of claim 26, wherein the instructions are further executable by the processor to:
determine a first maximum value of the first windowed function;
determine a second maximum value of the second windowed function; and
select a greater of the first maximum value and the second maximum value, wherein decoding at least the portion of the UCI is based at least in part on the selection.

28. The apparatus of claim 27, wherein the instructions are further executable by the processor to:
compare at least one of the first maximum value or the second maximum value to a threshold; and
classify the UCI as a valid transmission based at least in part on the comparison.

29. A non-transitory computer readable medium storing code for wireless communication at a base station, the code comprising instructions executable by a processor to:
receive, from a user equipment (UE), uplink control information (UCI) including a plurality of resource units (RUs) that each include at least one slot containing a set of data symbols and a set of reference symbols;
calculate, for each slot of each RU of the plurality of RUs, a data symbol estimate based at least in part on the set of data symbols of the slot and a reference symbol estimate based at least in part on the set of reference symbols of the slot; and
decode at least a portion of the UCI based at least in part on the data symbol estimates and the reference symbol estimates.

30. The non-transitory computer-readable medium of claim 29, wherein the instructions are further executable by the processor to:
compute a first hypothesis function and a second hypothesis function based at least in part on a frequency-domain pilot sequence and a frequency-domain data sequence.
